(19) United States
(12) Patent Application Publication
(10) Pub. No.: US 2017/0219202 A1
(43) Pub. Date: Aug. 3, 2017

(54) OPTICAL LIGHTING SYSTEM AND METHOD

(71) Applicant: U.S. APPLIED PHYSICS GROUP, LLC, TITUSVILLE, FL (US)

(72) Inventor: JAMES M. HOFFMAN, Titusville, FL (US)

(73) Assignee: U.S. APPLIED PHYSICS GROUP, LLC, TITUSVILLE, FL (US)

(21) Appl. No.: 15/500,525

(22) PCT Filed: Aug. 28, 2015
(86) PCT No.: PCT/US15/47607

§ 371 Date: Jan. 30, 2017

Related U.S. Application Data
(60) Provisional application No. 62/043,028, filed on Aug. 28, 2014.

(51) Int. Cl. F21V 29/89; F21V 7/04; F21V 7/08; F21V 29/76; F21S 8/08

(52) U.S. Cl. CPC F21V 29/89; F21V 29/763; F21S 8/08; F21V 7/08; F21V 7/041; F21Y 2115/10

(57) ABSTRACT

An LED lighting array for illuminating an area with the lighting array comprising a plurality of LED devices set in conical or elliptically conical reflectors, each of which is mounted upon a plate, each of which may be set at various angles to one other, and each of which is backed by a series of elements, first a copper support element, then an optional layer of graphite foam, followed by an aluminum plate, and then an arrangement of copper fins operably lined to a thermal mass mate. The copper support element includes support planes that are off-set relative to each adjacent plate and are in at least three different planes relative to each other. The backing plates may efficiently dissipate heat produced by the LEDs. The apparatus can be mounted upon a stand to illuminate an area such as a portion of a car park, building entrance or the like.

### CROSS REFERENCE TO RELATED APPLICATIONS AND INCORPORATION BY REFERENCE

This international patent application, filed under the Patent Cooperation Treaty (PCT), claims the benefit of U.S. provisional patent application No. 62/043,028, titled OPTICAL LED LIGHTING SYSTEM AND METHOD, filed in the United States Patent and Trademark Office (USPTO) on Aug. 28, 2014, which is hereby incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

Field of the Invention

The present invention relates to the field of light fixtures, and systems and methods for illuminate areas or surfaces. More particularly, the invention relates to the field of light fixtures for use in illuminating surfaces such as parking lots, athletic fields, high bay assembly areas, museums, the interior spaces of large buildings or other structures such as aircraft hangers, manufacturing assembly areas, government buildings, atriums, outdoor gymnasiums, churches, building entrances, vacant lots, and the like.

Background Art

The present invention relates to a light fixture, system and method for illuminating a desired surface. More particularly, the invention relates to a light emitting diode (LED) lighting array for illuminating an area with the lighting array comprising a plurality of LED devices including the LED mounts set in reflectors, each of which is mounted upon a plate, each of which is set at various angles to each other, and each of which is backed by a series of elements (excluding the LED carrier socket and LED), first a copper support element, then an optional layer of graphite foam, followed by an aluminum plate, and then an arrangement of copper fins. The copper support element includes support planes that are off-set relative to each adjacent plate and are in at least three different planes relative to each other. The backing plates are designed for efficient dissipation of the heat from the LEDs. The entire apparatus can be mounted upon a stand or pole or the like, to illuminate an area such as a portion of a car park, building entrance or the like.

Description of the Related Art

Light fixtures and systems have been developed for various applications, but most of them have been addressed to a single source reflective module, which creates a roughly circular pattern but provide an uneven light distribution pattern. Such lighting systems have been known to be very inefficient. Some of these systems include existing street lights, high bay lights, floodlights, and parking lot lights and the equivalents.

Most non-LED light fixtures are very power hungry and supply a great deal of light. That is, roughly 30-40% of this light is wasted in directions other than the desired area to be lit (e.g., the road or parking lot areas). There are many known LED replacements for such existing non-LED light fixtures. However, most of these LED light fixtures are also power hungry and deliver decreased areas of illumination.

Light fixtures have been employed to provide illumination for a wide variety of applications including, for example, parking lots or garages to increase safety. Recently, LED technology has sufficiently advanced that LEDs may be used as the light source for these types of light fixtures. One challenge created by LEDs is the dissipation of heat from the LEDs. Heat has at least two detrimental effects on an LED. First, light output is inversely proportional to the junction temperature of an LED, thus the higher the temperature, the less light emitted by the LED. Second, the life span of the LED is also inversely proportional to the junction temperature of an LED, so the higher the temperature, the quicker the LED degrades over time. Therefore, the heat created when the LED produces light must be dissipated to improve the light output and life span of the LED. Conventional LED light fixtures often include heat sinks with fins which are grouped together and protrude vertically from a top of the fixture. However, this method and arrangement may stifle airflow, which is an important factor in dissipating heat. Physical obstructions, e.g., a bird nest, may be situated on a top surface created by the fins, and the nest insulates the fins which reduces the ability to dissipate the heat generated by the LEDs.

Lights designed to serve illumination functions are designed to produce light of different intensity, duration and pattern. The prior art contains numerous examples of alternative light sources, reflectors and lenses arranged to produce particular intensities and distributions of light suited for a particular purpose. Of primary concern to designers of lights are efficiency and accuracy. By efficiency, it is meant that lighting designers are concerned with producing the maximum amount of light measured in candelas per unit of energy applied and transforming that light into a useful pattern with minimal losses. The light fixture must also distribute the available light as accurately as possible in the desired pattern. Lenses and other means used for bending and shaping light cause light losses due to differences between the refractive index of the lens material and the air surrounding the lens. Any light that is scattered, i.e., not accurately directed in the desired pattern, is effectively lost through dispersion.

Until recently, LEDs, while efficient producers of light in terms of candelas per watt of energy used, were extremely limited in the quality of light produced (candela vs. viewing angle), rendering them unsuitable for many applications. The viewing angle is the angle, measured with respect to the axis through the center of the lens of the LED, where the light intensity has fallen to fifty (50%) of the on-axis intensity. For example, a very bright LED, producing 3 to 5 candela may have a very narrow viewing angle of 8 to 15 degrees.

Recent advances in LED technology have resulted in LEDs having significantly improved light output. High-output (high flux) LEDs may now be a practical light source for use in signaling and warning illumination. Even though high-output LEDs have significantly greater luminous flux than previous LEDs, the total luminous flux is still relatively small, e.g., in the range of 5 to 20 candela, but will have a very wide viewing angle of 110 to 160 degrees. Thus, these newer LEDs produce a half globe of light in contrast to a directed spot of light with the older LEDs. Thus it is necessary to accumulate multiple LEDs in a compact array and externally focus their light output to produce a light source with luminous intensity sufficient for many applications.

LEDs are attractive to lighting designers because the light they produce is typically of a very narrow spectral wavelength, e.g., of a single pure color, such as red, blue, green, amber, etc. In the prior art, to achieve a colored light output, white light was produced and typically filtered through a colored lens or other colored material, such as a colored glass bulb to produce the desired light color. This causes a very large waste of light and the electrical energy used to produce the light, making such prior art devices very inefficient. LEDs are extremely efficient producers of colored light because the particular chemical compound used in the die of the LED, when excited by electrical current, produces a monochromatic band of energy within the visible light spectrum. For example, a red LED will generate a narrow wavelength of light in the visible red spectrum. No external color filtering is needed, significantly improving the efficiency of the light source. Further, LEDs are directional light sources. The light produced from an LED is primarily directed along an optical axis through the center of the lens of the LED. However, and in particular with the more recent high-output LEDs, a significant portion of the light is also directed out the sides of the lens of the LED. If the limited light output of an LED is to result in a practical signaling or illuminating device, as much of the light produced by each LED must be captured and directed in the desired light pattern as possible.

Known existing systems include a high-flux LED assembly in which an array of LEDs are provided with a reflector surrounding each LED. A conical reflecting surface collects and redirects light escaping from the LED at a large angle relative to the LED optical axis. The conical reflectors redirect such wide angle light out the face of the assembly, increasing the effective light contribution of each LED. The high-flux LED assembly also discloses connecting the conical reflectors with grooves to improve the wide-angle visibility desirable in a warning or signaling light application. By concentrating a number of high-output LEDs in a relatively small area and reflecting the light produced in a desired pattern, a very efficient and effective signaling and/or warning light is provided.

While the high-flux LED assembly of such a system has proved successful for its desired application, further efficiencies are possible. That is, the conical reflectors redirect light incident upon them out the face of the light assembly over a range of angles where the angle of the escaping light depends on the angular relationship between incident light and the reflecting surface. Such an arrangement, while desirably redirecting light out the front face of the assembly, undesirably does so over a range of angles. Some of the reflected light reinforces light output of the LED. Other light is reflected at random angles that fail to reinforce the light output of the LED and is effectively lost by being dispersed. The light pattern produced is essentially a series of bright points of light having somewhat improved wide-angle visibility due to the grooves connecting the conical reflectors.

It is also known in the art to use parabolic reflectors to collimate the light output from prior art light sources such as halogen bulbs or xenon flash tubes, such as a wide-angle warning light using a parabolic reflector comprised of a linear parabolic section including parabolic dish ends. The reflector is configured with a reflector having a linear focal axis similar in configuration to the extended length of the xenon flash tube light source.

As exemplified in the existing art, reflectors for light assemblies are typically configured to complement the form of the light source, e.g., point light sources are provided with reflectors having axial symmetry and linear light sources are provided with reflectors having linear symmetry. The conventional approach generally involved matching the reflector to the light source to produce maximum light output from a light assembly.

Accordingly, there is a need for an improved lighting fixture, system and method utilizing the next generation LEDs to provide improved heat management, reduced energy consumption, and which maximizes the advantages of LED lighting. Further, there is also a need to provide a lighting fixture, system and method having a performance advantage over traditional lighting solutions and other known LED lighting solutions.

### BRIEF SUMMARY OF THE INVENTION

The present invention, in the several embodiments described herein, relates to a lighting system for illuminating an area, the lighting array comprising at least one, but preferably a plurality, of lighting devices, which may be are but are not necessarily light emitting diodes or light emitting diode (LED) arrays, and method for illuminating a desired surface with a predetermined light intensity distribution pattern which may be non-circular and asymmetrical. In a preferred embodiment, the invention comprises at least one light emitting diode (LED) lighting array comprising one or more LEDs for illuminating an area, the lighting array preferably comprising a plurality of LEDs, which may further comprise LED mounts, set in reflectors, each of which may be mounted upon a plate, each of which is set at various angles to each other. In a first embodiment each of the LED light assemblies is backed by a series of elements comprising a copper support element, then an optional layer of graphite foam, followed by an aluminum plate, and then an arrangement of copper fins. The copper support element includes support planes that are off-set relative to each adjacent plate and are in at least three different planes relative to each other. The backing plates, or heat fins, of the invention are designed for efficient dissipation of the heat from the LEDs. The lighting system of the invention can be mounted upon a stand or pole or other structure to illuminate an area such as a portion of a car park, building entrance or the like; or may be suspended from an overhead structure such as a ceiling, overhead beam, truss, or the like.

Described therein are a first embodiment of the invention, primarily intended for outdoor lighting such as may be utilized in parking lots, athletic fields and the like; and a second embodiment of the invention, primarily intended for indoor lighting such as may be utilized in high bay assembly facilities, museums, large public buildings, and the like.

The first embodiment of the lighting system of the invention comprises a plurality of light emitting diode arrays, wherein each of said light emitting diode arrays is disposed within an elliptically conical reflector having an plane and an optically reflective interior surface and a thermally conductive support structure having an axis; wherein each of the light emitting diode arrays and each of the elliptically conical reflectors are attached to and in thermal communication with said support structure, and wherein the attachment to said support structure is thermally conductive so that heat is transferred from each of said light emitting diode arrays through said support structure to a heat dissipating heat sink. At least one of light emitting diode arrays is attached to the support structure such that said the axis of said conical reflector is disposed at a pre-determined angle to the thermally conductive support structure plane. Further, the thermally conductive support structure comprises a base plate comprised of a thermally conductive material and having a first side and a second side; a carbon foam layer; a back plate comprised of a thermally conductive material and having a first side and a second side; and a plurality of heat fins comprised of a thermally conductive material; wherein the light emitting diode arrays are attached to and in thermal communication with the first side of said base plate, the carbon foam is sandwiched between and in thermal communication with the second side of said base plate and the first side of the back plate, and the heat fins are attached to and in thermal communication with the second side of the back plate.

In the second embodiment of the of the lighting system of the invention, the thermally conductive support structure comprises at least one light group subassembly having an axis and comprising an inner support plate having a first side and a second side, comprised of thermally conductive material; an intermediate heat sink plate having a first side and a second side, comprised of thermally conductive material; a heat sink back plate having a first side and a second side, comprised of thermally conductive material; and a plurality of graphite foam blocks; wherein the plurality of light emitting diode arrays are attached to and in thermal communication with the first side of said inner support plate, at least some of the plurality of carbon foam blocks are sandwiched between and in thermal communication with the second side of the inner support plate and the first side of the intermediate heat sink plate; and wherein at least some of the plurality of carbon foam blocks are sandwiched between and in thermal communication with the second side of intermediate heat sink plate and the first side of the intermediate heat sink back plate. Further, the second embodiment of the lighting system of the invention is further defined as comprising a plurality of light group subassemblies. Further, the second embodiment of the lighting system of the invention is further defined as each of the light group subassemblies is disposed in a circular pattern, each of the light group subassemblies in the circular pattern being evenly distributed in the pattern, and said circular pattern having a center, through which a lighting system axis passes orthogonal to the plane of the circular pattern. And still further, the second embodiment of the lighting system of the invention may be further defined as the axis of each of said light group subassemblies being canted at an offset angle to the lighting system axis to achieve a predetermined lighting intensity distribution pattern, and in a further embodiment the offset angle is twenty degrees.

The various embodiments described herein are intended as exemplary descriptions of some of the embodiments of the invention, and not as an exhaustive depiction of all embodiments covered by the claims.

The invention also comprises a method of illuminating a predetermined area by forming a desired light intensity distribution pattern on said area, comprising the steps of assembling a plurality of light emitting diode arrays; disposing the plurality of light emitting diode arrays in elliptically conical reflectors, and disposing the plurality of light emitting diode arrays in at least three planes relative to one another; and providing electrical power to each of said plurality of light emitting diode arrays to stimulate said light emitting diode array to emit light; wherein the shape, location and orientation of the plurality of reflectors provides a pre-determined combined asymmetrical light intensity distribution pattern on the area; and wherein the light intensity distribution pattern is a superposition of light emitted from said light emitting diode arrays, directly and reflected from said reflectors, onto the area.

There are numerous advantages to the lighting system and method of the present invention. The present invention is a lighting system that may, in one of many examples, consume 43 Watts (W) of power while delivering 4,000 lumens of light to an area to be illuminated. This may be compared to a 540 W lumen metal halide parking lighting fixture that delivers 25,000 lumens to an area to be illuminated. The system includes custom optical components and novel high efficiency heat sinks. The lighting system and method of the invention is distributed on the illuminated surface in an even and tailorable blanket of illumination, which is vastly superior to the uneven lighting provided by lighting fixtures of the prior art. The light source temperature is lowered by a highly conductive thermal path between the light source and a specialized heat transfer system that removes thermal energy from the light source.

It is an object of the present invention to provide a novel lighting solution that provides a significant performance advantage over traditional lighting solutions. The performance advantage of the lighting system design according to the first embodiment of the invention has been proven by exchanging existing 540W metal halide lamps with a 43 W design according to the first embodiment of present invention, where both fixtures illuminated an approximate area of 15,000 square feet (sq. ft.). The resulting reduction in energy required by the first embodiment of present invention is more than 90% and the lifetime of the lighting fixture is projected to exceed 20 years. Exemplary calculations that show the junction temperature of the LEDs within the system according to the first embodiment of present invention are as follows: Tj=Tc+RΘjc*W (where Tj is LED junction temperature in oC, where Tc is case temperature in oC, where RΘjc is thermal resistance from a Tc measuring point in oC/W, and where W is the input power in watts); Tj=42.5 oC+1.7 oC/W*4.78 W; and Tj=50.626 oC (where ambient temperature was 21 oC, where a thermal resistance of 1.7 oC/W was used as a worst case scenario, and where the actual Tj could be as low as 49.19 oC using a typical value of 1.4 oC/W). Accordingly, the system and method of the present invention substantially reduces the energy consumption of a wide range of lighting fixtures including those using LEDs, and reduces maintenance and replacement cost due to the extended lifetime.

As an alternative first embodiment of the present invention, instead of oxygen-free high thermal conductivity (OFHC) copper alloy 101, any other known copper alloy may be used as heat sink material, as may be other materials that are known thermal conductors. The reflectors comprising the present invention are preferably made from ABS plastic coated with a reflective material, preferably an enhanced specular reflector (ESR) material, but the design of each individual optic may be such that they are one piece (i.e., where the reflective material and ellipse are a single finished piece). Alternatively, the copper heat sink fins may be substituted with aluminum fins (e.g., AL 1100 fins). Any manufacturer's LEDs may be utilized in the invention, and the LEDs of the invention may comprise a combination of LEDs exhibiting differing spectral and power outputs. It is not necessary that each of the plurality of LEDs comprising the system and method of the invention be the same. Optionally, the number of LEDs comprising the invention may vary depending on the specific LED package used. New types of LEDs that may be produced in the future will likely be compatible with the process and system of the invention, and these are within the scope of the invention.

In another aspect of the invention, provided is a light module that includes an LED array, a reflective assembly coupled to the LED array, where the reflective assembly includes a lower member having a frame, wherein the frame has an opening corresponding to the LED array. The frame and LED array are preferably located in the same plane. The light module further includes one or more reflectors, forming a reflective assembly comprising a plurality of LED lights. The shape, geometry and profile of such reflective assembly provides a pre-calculated combined non-circular asymmetrical light intensity distribution pattern, wherein the light distribution pattern is a superposition of light reflected from each of the reflectors, and light directed into the intensity distribution pattern directly from the LED array, resulting in a predetermined combined light intensity pattern on the illuminated area.

In still another alternate aspect of the invention, provided is a method of forming a pre-determined non-circular asymmetrical light intensity distribution pattern in a plane of illumination, including emitting light from a LED array, and reflecting a portion of the emitted light from a multi-reflective array assembly, wherein the reflective array assembly includes a frame having an opening corresponding to the LED array, wherein the frame and LED array are located in the same plane, wherein the reflective array assembly further includes an arbitrary multi-reflective array assembly having a shape, geometry, and profile providing a pre-calculated combined non-circular asymmetrical intensity distribution pattern that is a superposition of light reflected from each of the plurality of reflectors, and light directed into the intensity distribution pattern directly from the LED array.

It is an object of the present invention to provide a new and improved LED light assembly which efficiently uses a high-output LED to produce highly favorable illumination characteristics.

It is another object of the present invention to provide an improved lighting fixture, system and method utilizing the next generation LEDs to provide improved heat management, reduced energy consumption, and which maximizes the advantages of LED lighting that are controllable for light output intensity.

It is still another object of the invention to provide a lighting fixture, system and method having a performance advantage over traditional lighting solutions and other known LED lighting solutions.

It is yet another object of the invention to provide a multi-reflector LED lighting fixture having a longer life than traditional lighting solutions depending upon the junction temperature management enabled by the system and method of the invention (i.e., providing junction temperatures substantially lower than other LED lighting solutions).

It is a further object of the invention to provide a system and method for an LED lighting system and method providing lower maintenance costs due to longer life spans thereof, due to lower LED operating temperatures enabled by the system and method of the invention, which allows a user to determine the lowest operating current needed in each LED of the system to provide a predetermined light intensity distribution pattern adapted for a specific use.

It is still a further object of the invention to provide a system and method for an LED lighting system that typically last two times longer than traditional LED lighting solutions, and have significantly lower operating costs by requiring less maintenance and less frequent replacement.

It is still another object of the invention to provide a novel multi-reflector LED lighting fixture or solution using the highest quality LED arrays, leveraging color and light distribution characteristics of various LED arrays, managing the junction temperature of the LED arrays utilizing proprietary technology, and employing unique methodologies to further reduce energy consumption.

It is still a further object of the invention to provide an enhanced method and system for lighting solutions for parking facilities, vehicle dealerships, university facilities, government or municipal facilities, warehouse facilities, athletic fields or facilities, etc.

The above and other aspects, features and advantages of the present invention will become apparent from the following description read in conjunction with the accompanying drawings, in which like reference numerals designate the same elements.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the scope of the invention. In the drawings:

FIGs. 1A and 1B depict front and side perspective views, respectively, of the assembled lighting fixture or system according to a preferred embodiment of the first embodiment of the present invention.

FIG. 2 depicts an exploded elevated perspective view of a full enclosure assembly of a version of a first embodiment of the LED lighting system of the present invention.

FIGS. 3A-3C depict an embodiment of an LED array (e.g., by Nichia) for use as a light source in accordance with the present invention, with FIG. 3A showing a top plan view thereof, and FIGS. 3B-3C showing side plan views thereof.

FIGS. 4A-4D depict a base plate (which may be fabricated, for example, from OFHC 101 copper (Cu)) for use with an LED array such as the one depicted in FIGS. 4A-4C in accordance with a first embodiment of the present invention, with FIG. 4A showing an elevated perspective view thereof, FIG. 4B showing a top plan view thereof, FIG. 4C showing a side plan view thereof, and FIG. 4D showing a front plan view thereof.

FIG. 5 depicts a top plan view of a schematic representation of the base plate array depicted in FIGS. 4A-4D, further showing exemplary dimensions thereof in accordance with the preferred embodiment of the present invention.

FIG. 6 depicts a perspective view of graphite foam backings for optional use with the light sources of the invention, including LED light sources.

FIG. 7 depicts a perspective view of the back plate of the first embodiment of the invention, which may be, for example, fabricated from aluminum (Al) for optional use with the light sources of the invention, including LED light sources.

FIGS. 8A-D show a first configuration of one heat sink fin (e.g., an OFHC 101 copper fin or optionally any other suitably operable thermal transfer medium and thermal mass) for use as a backing to the LED light in accordance with the first embodiment of the present invention, with FIG. 8A showing an elevated perspective view thereof, FIG. 8B showing a side plan view thereof, FIG. 8C showing a front plan view thereof, and FIG. 8D showing a top plan view thereof.

FIG. 9 shows an expanded top plan view of the copper heat sink fin shown in FIGS. 8A-D.

FIGS. 10A-D show a second configuration of a second heat sink fin (e.g., a second shape or configuration of an OFHC 101 copper fin) for use as a backing to the LED light in accordance with the first embodiment of the present invention, with FIG. 10A showing an elevated perspective view thereof, FIG. 10B showing a side plan view thereof, FIG. 12C showing a front plan view thereof, and FIG. 10D showing a top plan view thereof.

FIG. 11 shows a flat pattern view of the heat sink fin shown in FIGS. 10A-D.

FIG. 12 depicts a perspective view of the second embodiment of the light fixture assembly of the invention comprising six light group subassemblies, each light group subassembly comprising five light reflector assemblies.

FIG. 13 depicts an exploded perspective view of the second embodiment of the light assembly of the invention comprising six light group subassemblies each light group subassembly comprising five light reflector assemblies, and each light group subassembly attached to a support block by way of a support arm, the support block being attached to an electronics bottom cover.

FIG. 14 depicts a perspective view of a light reflector assembly 100 of the invention.

FIG. 15 depicts an orthogonal side view of one half of a light reflector assembly of the invention.

FIG. 16 depicts an orthogonal top view of two halves of a light reflector assembly of invention, further showing the two halves of the light reflector assembly being motivated together to form a completed reflector.

FIG. 17 depicts a perspective view of two halves of a light reflector assembly of the invention, further showing the two halves of the light reflector assembly being motivated together to form a completed reflector.

FIG. 18 depicts a cross-sectional view of a light reflector assembly of the invention as utilized in the second embodiment of the invention, depicting the mounting of the light reflector assembly onto its support and heat sink structures, and further depicting the mounting of a light group subassembly onto a support rod.

FIGS. 19A-19C depict a support block of the second embodiment of the invention: FIG. 20A depicts a top view of a support block of the second embodiment of the invention, FIG. 20B depicts a side view of a support block of the second embodiment of the invention, and FIG. 20C depicts a bottom view of the support block of the second embodiment of the invention.

FIG. 20 depicts a cross-sectional view of a support block of the second embodiment of the invention.

FIG. 21 depicts a cross-sectional view of the support rods of the invention attached to the support block of the invention as relates to the second embodiment of the invention.

FIGS. 22A and 22B depict the illumination pattern of a single light reflector assembly of the second embodiment of the invention.

FIGS. 23A and 23B depict the illumination pattern of a single light group subassembly of the second embodiment of the invention, comprising five light reflector assemblies.

FIGS. 24A and 24B depict the illumination pattern of a light fixture assembly of the second embodiment of the invention, in which the light fixture assembly of the invention comprises six light group subassemblies each comprised of five light reflector assemblies.

### DETAILED DESCRIPTION OF THE INVENTION

The following documentation provides a detailed description of the invention.

Several detailed illustrative embodiments of the present invention are disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “fainted” on another element, it can be grown, deposited, etched, attached, connected, coupled, or otherwise prepared or fabricated on the other element or an intervening element.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower”, can therefore, encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

As used herein, the term “elliptically conical” shall mean a cone having a length, a longitudinal axis, a small end having opening, and a large end having an opening, where the cone small end opening comprises a circle having a center and the cone large end opening comprises an ellipse having a center, and wherein the cone small end circle center and the cone large end ellipse center lie substantially on the longitudinal axis of the cone.

Whereas the embodiments presented below are described in terms of an LED or an array of LEDs, for a light source, any other light sources that may be approximately represented as point light sources may be contemplated as well within the scope and intent of the disclosure, including lasers, light emitting bulbs, and the like. As used herein, an array of LEDs may comprise one or more LEDs.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner

### The Embodiments of the Invention

A first embodiment of the invention, primarily intended primarily, but not exclusively, for outdoor use such as in illumination of parking lots, athletic fields, and the like is first described. Next, a second embodiment of the invention intended primarily, but not exclusively, for indoor use such as in illumination of indoor high bay assembly facilities, museums, large public buildings, hangars, churches and the like is next described.

### Description of the First Embodiment of the Invention

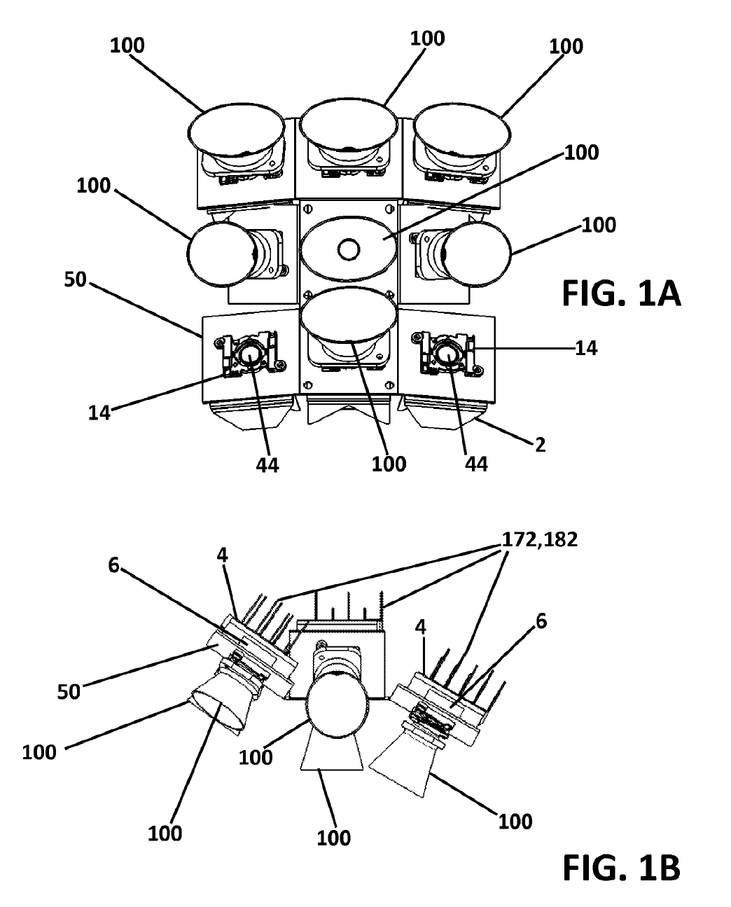

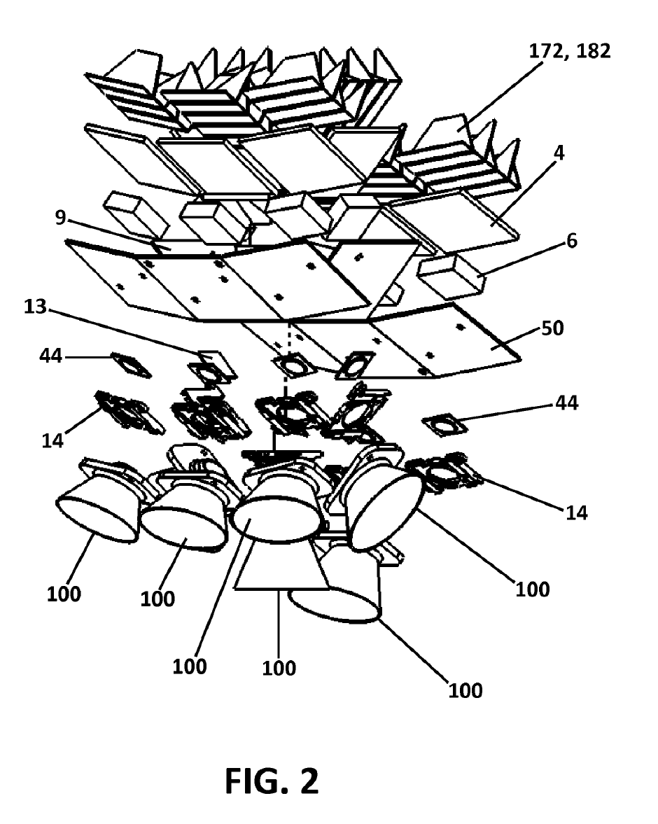

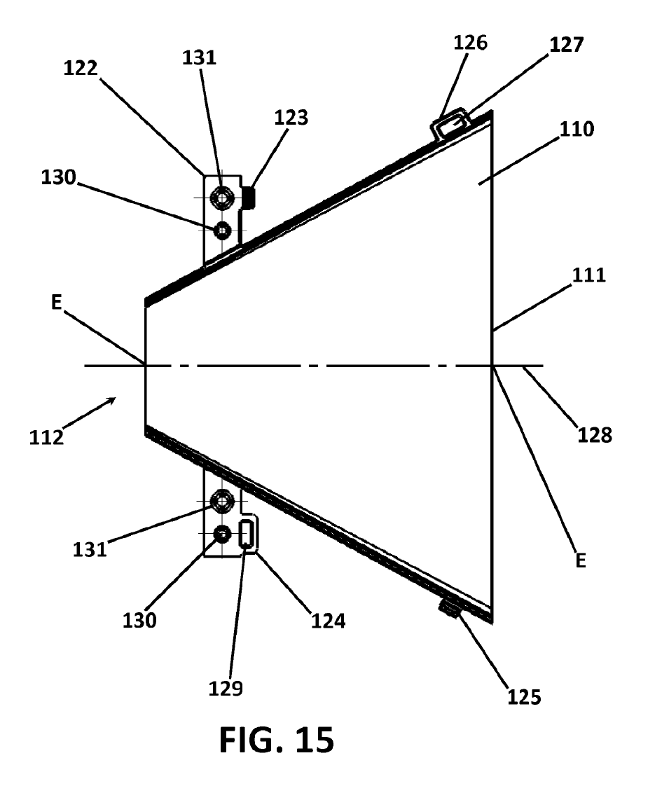

Referring first to FIGS. 1A, 1B, and 2, shown is one exemplary embodiment of an LED lighting system or assembly constructed in accordance with the first embodiment of the invention, depicting a plurality of light reflector assemblies 100 attached to base plate 50, and further showing a plurality of LED light arrays 44 attached to base plate 50, or, alternatively, to support frame 14, which is in turn attached to base plate 50. FIGS. 1A and 1B depict an assembly view of the first embodiment of the invention, in which two of the light reflector assemblies 100 have been removed in order to show LED light arrays 44. In the particular embodiment depicted, nine light reflector assemblies are shown. However, it is within the scope of the invention that the invention may be comprised of any number of light reflector assemblies 100. LED array 44 may be attached to and in thermal communication with base plate 50, which is in turn attached to and in thermal communication with back plate 4 with graphite foam 6 disposed therebetween, and back plate 4 is in thermal communication with a plurality of heat fins 182 or 172, in any combination, attached to a surface of back plate 4. Each of the attachments are preferably thermally conductive and may comprise compressible or other thermally conductive materials in each junction of two parts, so that thermal energy is efficiently transferred from LED array 44 through LED back support member 42, through base plate 50, through optional graphite foam 6, through back plate 4, through heat fins 182 or 172 and into the atmosphere. FIG. 2 shows an exploded elevated perspective view of a full enclosure assembly of the LED lighting system according to a preferred embodiment of the first embodiment of the present invention. Base plate 50, optional graphite foam 6, back plate 4, and heat fins 182 and 172 together form a thermally conductive support structure having an axis 901 running perpendicular to the surface of base plate 50 to which LED array 44 is attached, and running through a center of LED array 44 so that the axis is substantially collinear with the axis of light reflector assembly 100, depicted as axis 128 in FIG. 15.

FIG. 2 depicts an exploded perspective view of LED reflector assembly 10 including light reflector assemblies 100, which may be conical having a circular small end and an elliptical large end, and having backing plates 15, LED support frames 14, LED arrays 12 having back sides 13, and a base support assembly comprising a base plate 50 having a backside 9, a foam (e.g., graphite foam) support member 6, a back plate 4, and a heat sink fin arrangement 2. As depicted, a preferred embodiment of the first embodiment of the invention comprises at least 9 LED light arrays and reflector assemblies; however, it is within the scope of the invention that any other number of LED arrays and reflector assemblies may comprise the invention. As seen in FIG. 2, each LED array 44 is preferably mounted in optional support frame 14 which is attached on one side to light reflector assembly 100 and on the other side to a front side of base plate 50. Attached to a backside 9 of base plate 50 is a foam graphite support member 6, a back plate 4 and a heat sink fin arrangement 2. Preferably, the heat sink fins 102 and 172 are made of copper but other suitable materials, including thermally conductive materials such as aluminum, may be used to provide sufficient heat dissipation. Light reflector assemblies 100 are described in further detail below and are shown in further detail in FIGS. 15-18.

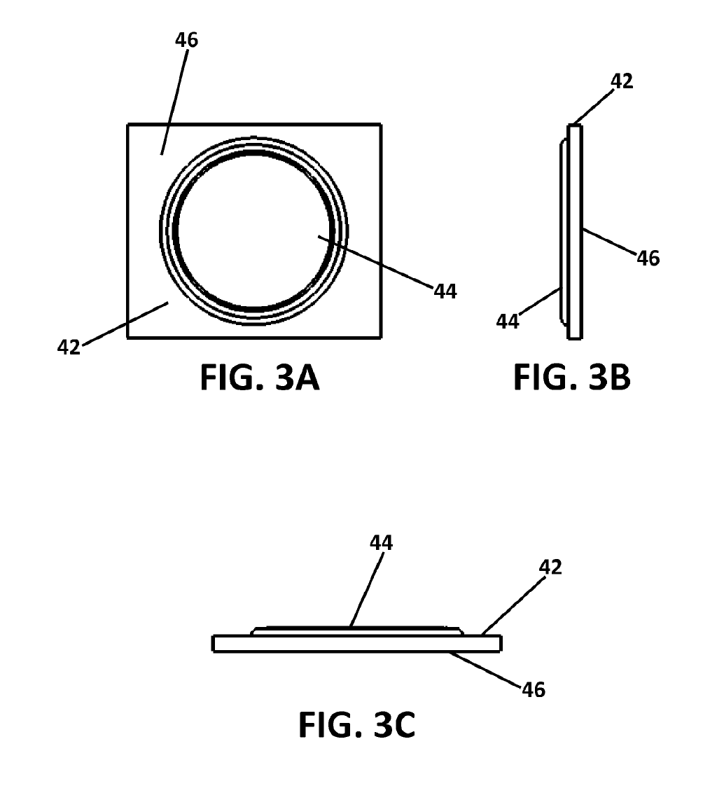

Referring next to FIGS. 3A-C, shown is an embodiment of an LED array 46 (e.g., one manufactured by Nichia) for use in accordance with the present invention. As seen in FIG. 3A, each LED array 46 comprises an array of LEDs 44 and a back support member 42. The entire LED arrangement may be mounted in an optional frame for attaching to light reflector assembly 100 (not shown in FIGS. 3A-3C, but shown in FIGS. 1A and 1B).

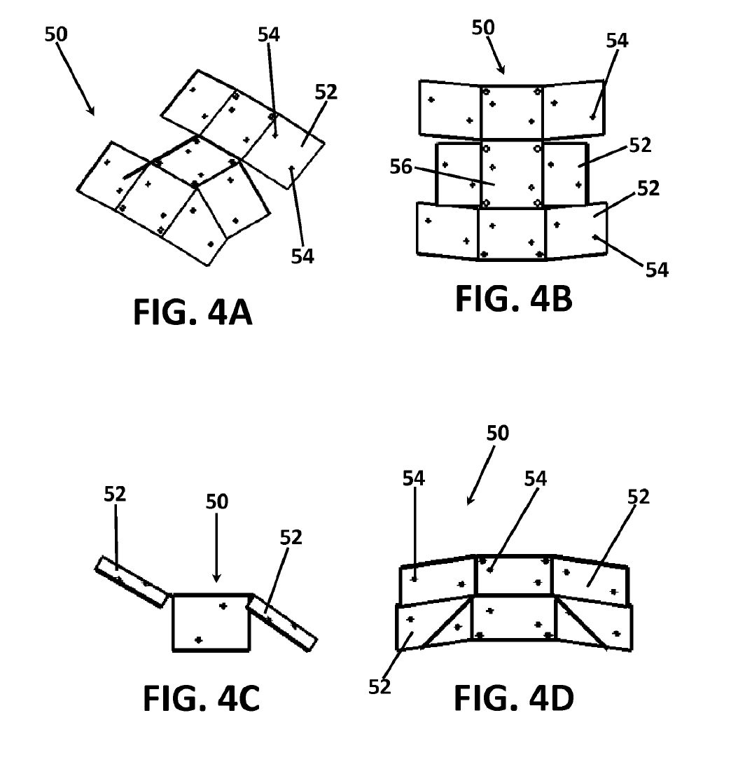

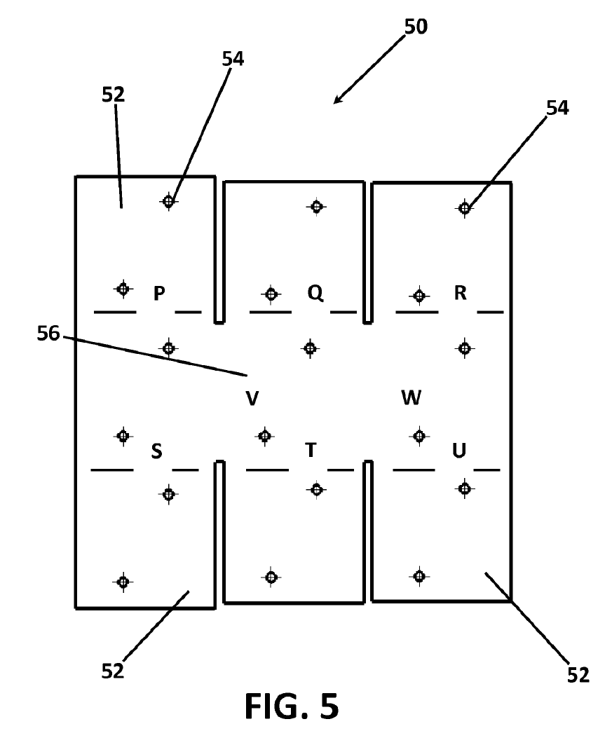

Turning next to FIGS. 4A-D, shown is a base plate 50 for use with the invention. Preferably, for example, base plate 50 is fabricated from Oxygen-Free High thermal Conductivity (OFHC) 101 copper. Also preferably, base plate 50 is comprised of a series of support plates 52, which may be part of a contiguous metal base plate 50 configured at angles off-set relative to each adjacent plate. Also preferably, the plurality of support plates 52 may be configured in at least three different planes relative to each other to provide optimal light distribution for the light assembly, as is shown further in FIG. 5 and as further described below. Also, each support plate 52 of the base support 50 comprises a plurality of openings 54 for alignment and attachment, for example using threaded fasteners, of each of the reflector assemblies 100. Various specific dimensions of a non-limiting, exemplary base support 50 and the various support openings 54 are seen in FIG. 5, which shows a top plan view of a schematic representation of the copper base plate array depicted in FIGS. 4A-D.

Referring now to FIG. 5, a plan, or flat, view of base plate 50, comprising a plurality of support plate areas 52, prior to bending is depicted. Each support plate 52 of the base support 50 comprises a plurality of openings 54 for alignment and attachment, for example using threaded fasteners, of each of the reflector assemblies 100. Base plate 50 may be formed into a desired shape intended to provide the angular orientation of the light reflector assemblies, by forming bends along fold lines P, Q, R, S, T, U, V, and W as follows, using the plane of the area 56 as a reference: at fold line V, bend up 35 degrees; at fold line W, bend down 30 degrees; at fold line P, bend up 10 degrees; at fold line Q, bend up 45 degrees; at fold line R, bend up 10 degrees; at fold line S, bend up 10 degrees; at fold line T, bend up 45 degrees; and at fold line U, bend up 10 degrees.

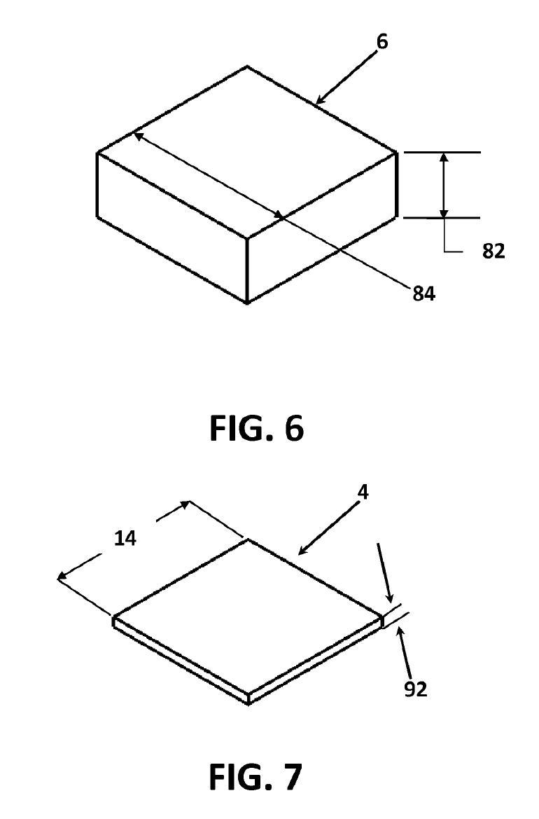

Referring next to FIGS. 6 and 7, an exemplary graphite foam block 6 and aluminum (Al) back plate 4, respectively, for optional use with the LED lighting fixture 10 of the invention, are shown. It is noted that graphite and aluminum are exemplary materials for use as the foam support 6 and back plate 4, respectively. Foam support 6 may be of thickness 82 and form a square of side length 84; likewise, back plate 4 may be of thickness 92 and form a square of side length 93. However, foam support 6 and back plate 4 need not be square but may take any shape desired. Foam support 6 and back plate 4 may be fabricated from any other materials known to be thermally conductive.

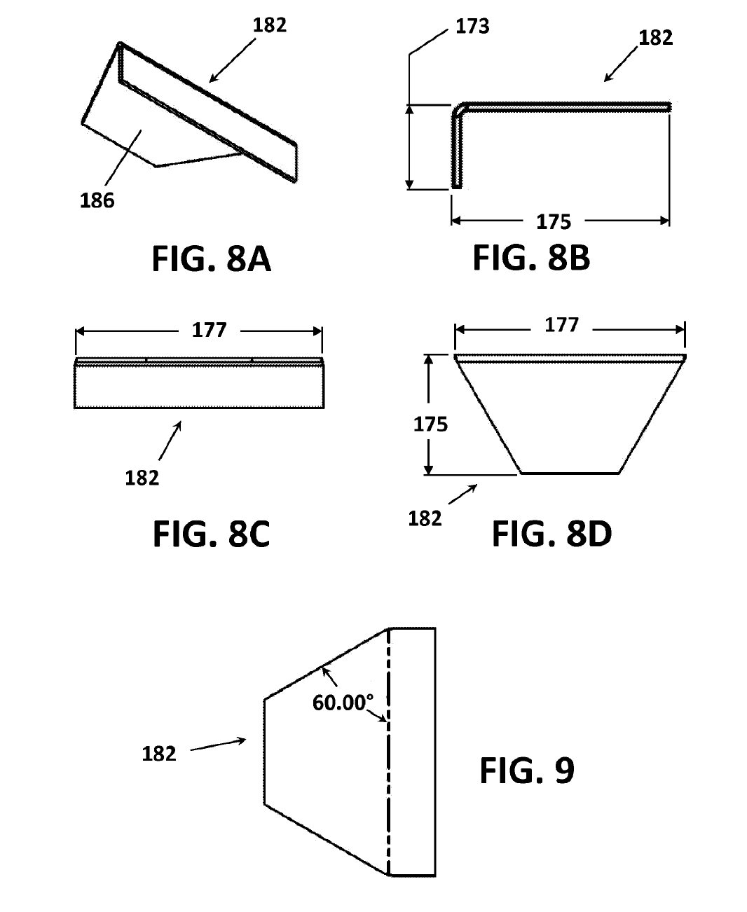

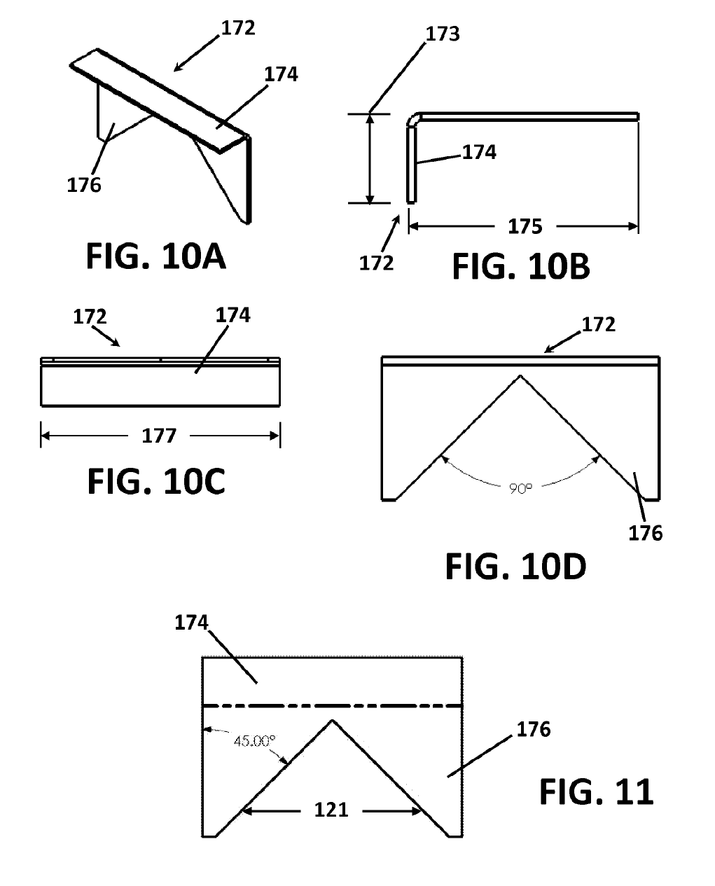

Referring next to FIGS. 8A-8D, 9, 10A-10D, and 11, shown are heat sink fins 102 and 172 which may, for example, be fabricated from any thermally conductive material but is preferably fabricated from OFHC 101 copper fin or equivalent thermal mass and thermal heat transfer material for use in a heat sink fin arrangement 2, depicted in FIG. 1, as a thermal backing to the LED light assembly 10 in accordance with the present invention. Optionally, it is noted that the fin arrangement may be in direct thermal communication with the chassis. Heat sink fins 102 and 172 are configured with specific geometries for appropriate heat dissipation and thermal transfer to enhance the life span of the LED arrays 12. For example, heat sink fins 102 and 172 may be fabricated to the following dimensions: 173=.39 in.; 175=1.02 in.; and 177=1.97 in. While specific dimensions, designs and configurations are shown, other shapes, profiles or configurations or geometries may be used in accordance with the invention.

### Description of the Second Embodiment of the Invention

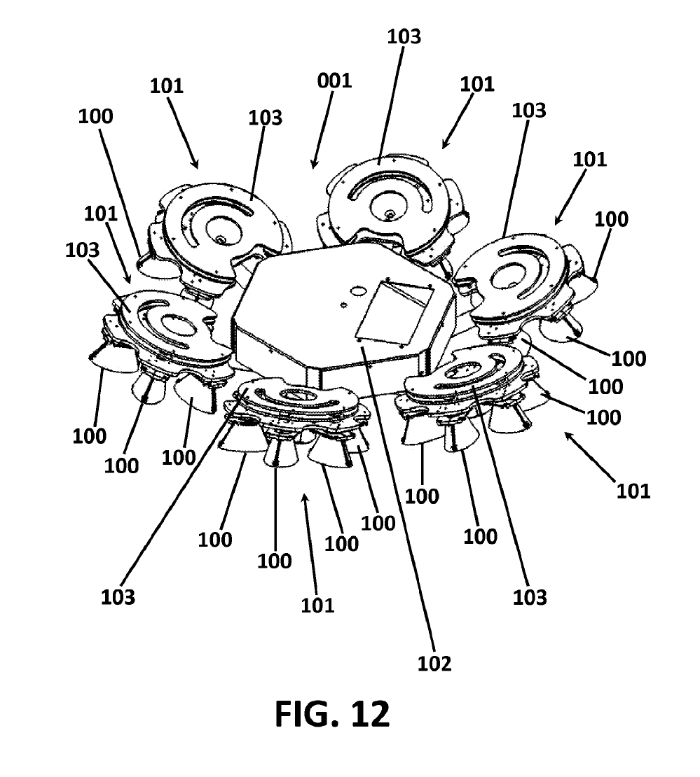

Referring now to FIG. 12, a perspective view of the second embodiment of the light fixture assembly of the invention 001 comprising six light group subassemblies 101, each light group subassembly comprising five light reflector assemblies 100 is depicted. In the embodiment depicted, the six light group subassemblies 101 are disposed in a circular pattern and equally spaced apart from one another, with each being spaced at approximately sixty (60) degrees apart from its two neighboring light group subassemblies. The light fixture assembly of the invention 001 may be comprised of any number of light group subassemblies 101, each being spaced apart equidistantly. Thus, the light fixture assembly of the invention 001 may comprise four light group subassemblies 101 based apart at 90 degrees, five light group subassemblies 101 spaced apart at 72 degrees, six light group subassemblies 101 spaced apart at 60 degrees, and so on. Furthermore, each light group subassembly 101 may be comprised of any number of light reflector assemblies 100. Thus, each light group subassembly 101 may be comprised of three light reflector assemblies 100, four light reflector assemblies 100, five light reflector assemblies 100, and so on. In the embodiment of the second embodiment of the light fixture assembly of the invention 001 depicted in the figures of the drawings, a preferred, but not limiting, embodiment of six light group subassemblies 101 each comprised of five light reflector assemblies 001 is depicted. However, it is within the scope of the description and claims of the invention 001 that any number of light group subassemblies 101, each comprising any number of light reflector assemblies 100, may comprise the invention. Heat sink back plate 103 and electronics top cover 102 are depicted for reference.

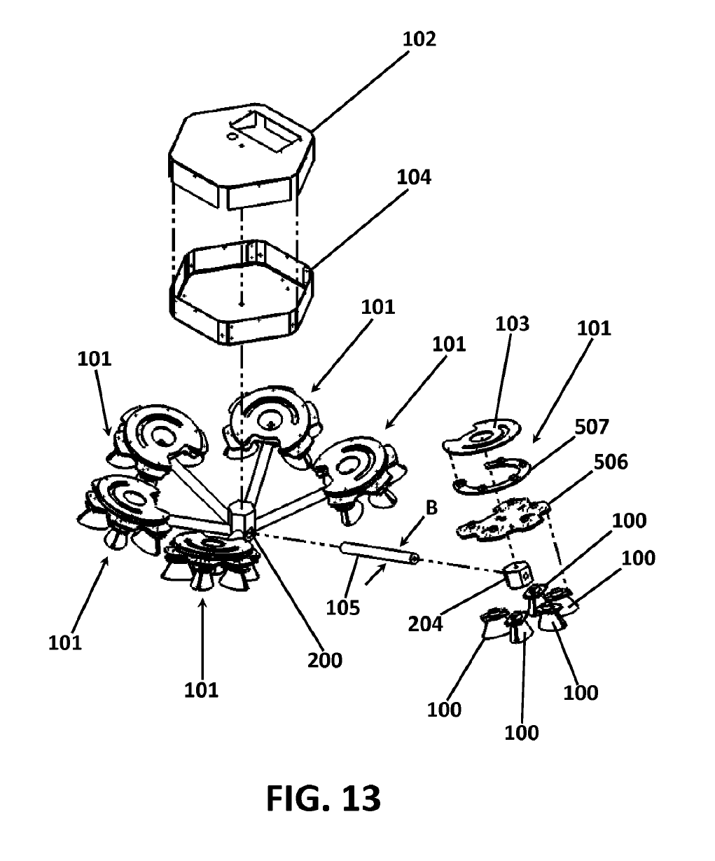

Referring now to FIG. 13, an exploded perspective view of the second embodiment of the light fixture assembly of the invention 001 comprising six light group subassemblies 101, each light group subassembly 101 comprising five light reflector assemblies 100, and each light group subassembly 101 attached to a support block 200 by way of a support arm 105, support block 200 being attached to an electronics bottom cover 104, is depicted. Electronics top cover 102 operates as a cover that is attachable to electronics bottom cover 104, forming an enclosure for electronics such as lighting power supplies and the like. The attachment of electronics top cover 102 to electronics bottom cover 104 may be by any means know in the mechanical arts such as rivets, chemical bonding, screws or other threaded engagements, or any other mechanical attachment means. Additionally, mechanical attachment points such as, for example, eyes or hooks may be attached to the upper side of electronics top cover 102 for attachment to chains or rope, or other equivalent structures, such that the light fixture assembly of the invention 001 may be suspended from an overhead structure such as a ceiling, beam or other structural member.

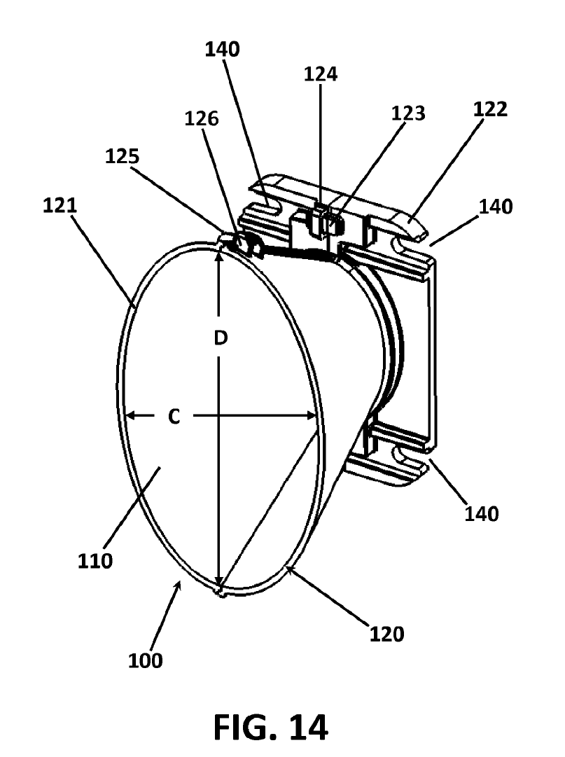

Referring now to FIG. 14, a light reflector assembly 100 of the invention is depicted in perspective view. Light reflector assembly 100 may be an elliptical cone or any conical shape, and may comprise two parts, a light reflector first-half 120 and a light reflector second-half 121 that are comprised of complementary joints and designed to be snapped together to form a completed light reflector of the invention. Light reflector first-half 120 and light reflector second-half 121 may be fabricated from any material, and by any process such as machining, molding, casting, and the like; but they are preferably molded from a plastic material such as, for example, Zeonor. Reflective surface 110 may be coated or layered with a reflective material. Any reflective material may be used to coat surface 110; however, the higher reflective nature of the coating material, the less optical loss will be incurred as light energy is reflected from reflective surface 110. Therefore, an optically reflective coating of higher optical reflectivity is desired. Testing has shown that deposition of aluminum on surface 110 provides an acceptable surface roughness and optical reflectivity of the finished surface 110. Likewise, mounting flange 122 may comprise mounting slots 140 for attachment to a structure or other surface.

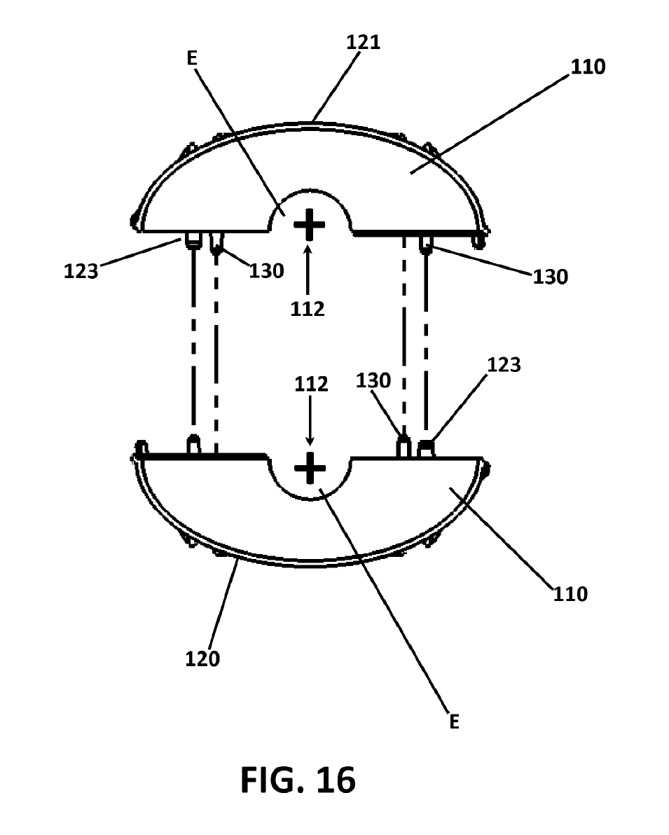

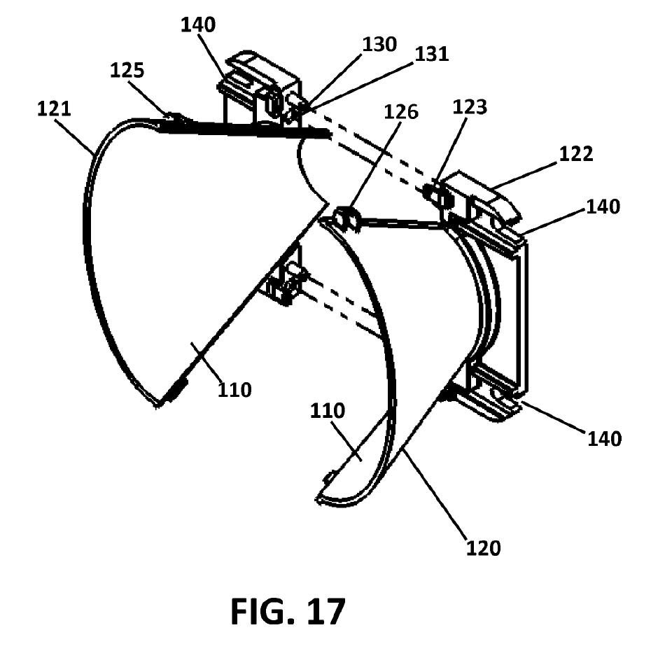

Still referring to FIG. 14, the mounting flange 122 of light reflector first-half 120 may further comprise flange tab 123, and mounting flange 122 of light reflector second-half 121 may comprise flange tab receiver 124 which is adapted to receive flange tab 123 in a retaining engagement which may also be releasable. Likewise, light reflector first-half 120 may further comprise reflector tab receiver 126, and light reflector second-half 121 may comprise reflector tab 125 which is adapted to receive flange tab 123 in a retaining engagement which may also be releasable. Thus, when light reflector first-half 120 and light reflector second-half 121 are motivated together, flange tab 123 engages flange tab receiver 124 by sliding into flange tab receiver 124 and being retained there; and reflector tab 125 engages reflector tab receiver 126 by sliding into reflector tab receiver 126 and being retained there, so that light reflector first-half 120 and light reflector second-half 121 are held together in a retaining engagement forming a completed light reflector as depicted in the figure. The location of the tabs and tab receivers of the invention on light reflector first-half 120 and light reflector second-half 121 is shown as exemplary in the figures. Light reflector first-half 120 may comprise any number of tabs or tab receivers; and, likewise, light reflector second-half 121 may also comprise any number of tabs or tab receivers, as long as the tabs and tab receivers of the invention are disposed so as to engage one another in a retaining engagement, that may also be a releasable engagement, such that, when light reflector first-half 120 and light reflector second-half 121 are motivated together, one or more tabs are received by one or more tab receivers such that light reflector first-half 120 and light reflector second-half 121 are held together in a retaining engagement forming a completed light reflector as depicted in the figure. The motivation of light reflector first-half 120 and light reflector second-half 121 together to form a completed light reflector of the invention is further depicted in FIG. 16 and FIG. 17.

Referring now to FIGS. 15, 16 and 19, an orthogonal side view of one light reflector half 120 or 121 of a light reflector assembly of the second embodiment of the invention is depicted in FIG. 15, an orthogonal front view of an assembled light reflector of the second embodiment of the invention is depicted in FIG. 16, and a perspective view of a light reflector first-half 120 and light reflector second-half 121 being motivated together to form a completed light reflector is depicted in FIG. 17. Reflector tab receiver 126 is depicted, which may further comprise reflector tab receiver opening 127 which is adapted to receive a reflector tab 125 from a mating light reflector in a retaining engagement, which may also be a releasable engagement, when a light reflector first-half 120 and a light reflector second-half 121 of the invention are motivated together to form a completed reflector as described above. Likewise, flange tab receiver 124 is depicted, which may further comprise flange tab receiver opening 128 which is adapted to receive reflector tab 123 from a mating light reflector in a retaining engagement to form a completed reflector as described above, which may also be a releasable engagement. In a preferred embodiment, dimension D is 2.80 inches, dimension C is 1.80 inches, and reflector small end opening diameter 112 is 1.36 inches, and reflector cone length is 2.00 inches. The resulting cone angle is 55.85 degrees inclusive.

Still referring to FIGS. 15, 16 and 17, light reflector first-half 120 and light reflector second-half 121 may further comprise at least one mating pin 130 adapted to be received by at least one mating pin receiver 131 from a mating light reflector half when a light reflector first-half 120 and light reflector second-half 121 are motivate together to form a completed light reflector assembly. The location of at least one mating pin 130 adapted to be received by at least one mating pin receiver 131 of the invention on light reflector first-half 120 and light reflector second-half 121 is shown as exemplary in the figures. Light reflector first-half 120 may comprise any number of pins 130 or pin receivers 131; and, likewise, light reflector second-half 121 may also comprise any number of pins 130 or pin receivers 131, as long as the pins 130 and pin receivers 131 of the invention are disposed so as to engage one another in a sliding engagement when light reflector first-half 120 and light reflector second-half 121 are motivated together. The motivation of light reflector first-half 120 and light reflector second-half 121 together to form a completed light reflector of the invention is further depicted in FIG. 16 and FIG. 17.

Still referring to FIGS. 15, 16 and 17, reflective surface 110 may a continuous conical transition from the reflector small end opening 112 to reflector large end opening 111. Reflector small end opening 112 and reflector large end opening 111 may be shaped so that when a light reflector first-half 120 and light reflector second-half 121 are motivated together to form a completed light reflector, small end opening 112 is shaped as a closed curvilinear shape having an center E disposed on light reflector axis 128, and likewise large end opening 111 is also a closed curvilinear shape having a center E disposed on light reflector axis 128. In the exemplary embodiment of the second embodiment of the light fixture assembly of the invention 001 shown in the drawings, small end opening 112 is circular having a diameter with a center E, and large end opening 111 is elliptical having a major axis D and minor axis C as depicted in FIG. 17. Thus, in the embodiment of the second embodiment of the invention shown in the figures, small end opening 112 and large end opening are coaxial on reflector axis 128.

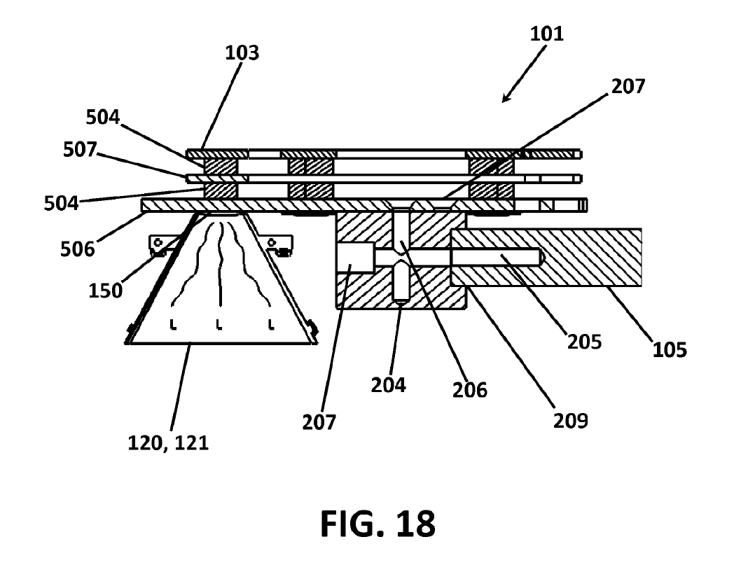

Referring now to FIG. 18, a cross section of a portion of a typical light group subassembly 101 of the invention is depicted, showing the attachment of light group subassembly 101 to support rod 105. Light reflector first-half 120 or light reflector second-half 121 are attached to a lower surface of inner support plate 506 by any means known in the art, but may, for example, be chemically bonded or attached using threaded fasteners. Inner support plate 506 may be attached to intermediate heatsink plate 507 by, for example, threaded fasteners, and likewise intermediate heatsink plate 507 may be attached to heatsink back plate 103 by any means known in the art, for example, threaded fasteners. The surfaces of inner support plate 506, intermediate heatsink plate 507, and heatsink back plate 103 all operate as heat radiating surfaces, causing heat generated by the light source to be radiated, causing the light source to experience a reduction in temperature. This may be very important, for example, when the light source is an LED, and it is desired that lifetime LED operating hours to be maximized by keeping the LED semiconductor junction at as low a temperature as possible. Inner support plate 506, intermediate heatsink plate 507, and heatsink back plate 103, which are preferably fabricated from thermally conductive material such as aluminum, are in thermal communication by operation of thermal transfer through graphite foam 504.

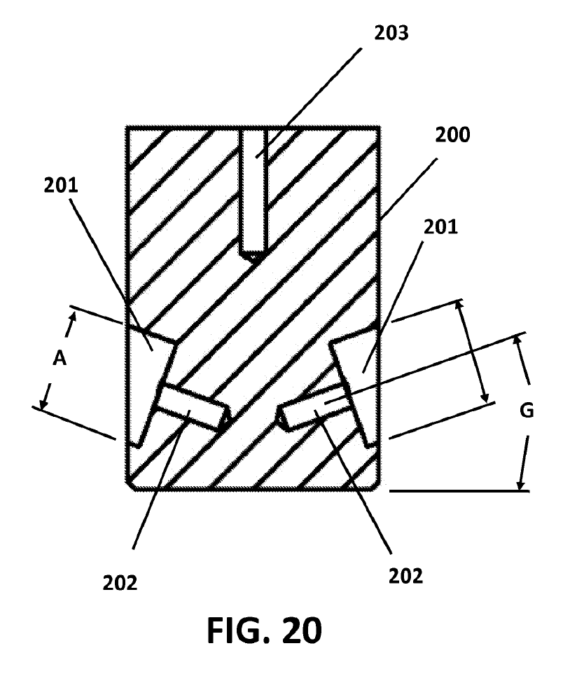

Still referring to FIG. 18, light group subassembly mounting block 204 may be attached to a lower surface of inner support plate 506 by means of a threading attachment. A male threaded countersunk head fastener may be inserted through countersunk hole 207 where it is received in a threading engagement by female threads disposed in fastener hole 206. Light group subassembly mounting block 204 may be attached to support rod 105 when support rod 105 is inserted into counter bore 209, where it may seat against the bottom of counter bore 209 and be attached there by means of a threaded fastener having male threads and being inserted into counter borehole 207, and where the male threads of the fastener are threadingly engaged with female threads disposed in fastener hole 205. In this manner a light group subassembly 101 may be attached to a support rod 105, which is in turn attached to support block 200 (not shown in FIG. 18 but shown in FIGS. 13, 19a, 19B, 19C, 20 and 21.

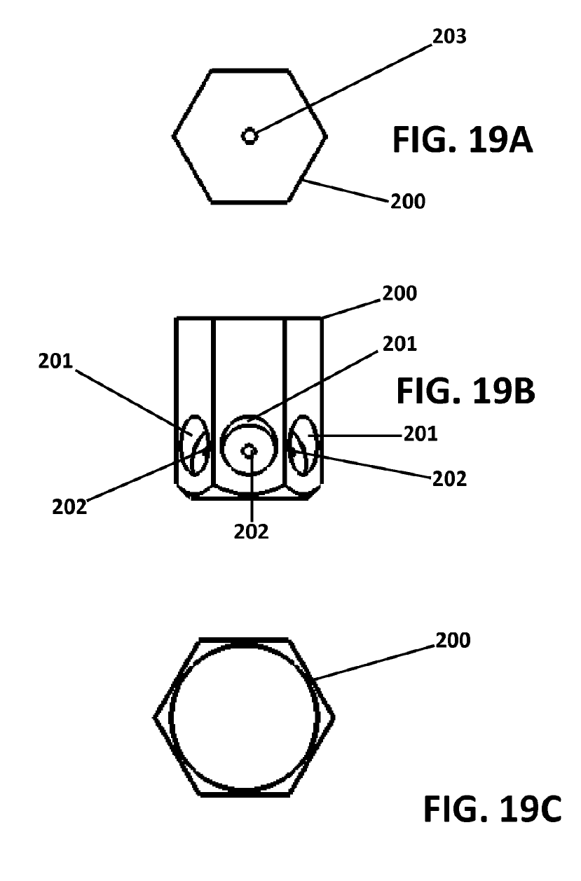

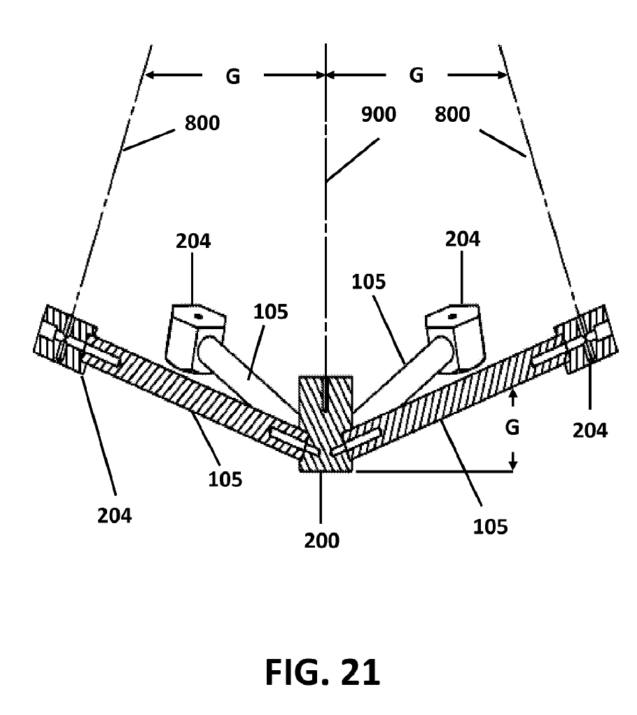

Referring now to FIGS. 19A, 19B, 19c, 20 and 21, the attachment of support rods 105 to support block 200 is depicted. Lighting system axis 900 is depicted in FIG. 21. Support block 200 may comprise counter boreholes 201 for receiving support rod 105. Counter bored holes 201 may further comprise fastener holes 202 which may be adapted to receive a smooth pin, or, alternatively, to threadingly engage a threaded fastener, protruding from an attaching end of support rod 105. Counterbored holes 201 may be disposed at counterbore angle G. Counterbore angle G, which operates to cant each light group subassembly axis 800 at an angle G to lighting system axis 900, may take any angle between 0 and 90 degrees, but is, for example, typically between 10 and 30 degrees, and is preferably 20 degrees. Support rod 105 may be received by counter bore hole 201 in support block 200 in a slight press fit engagement or a sliding engagement as depicted in cross-section view in FIG. 21, and may be retained there by operation of a smooth pin protruding from the attaching end of support rod 105 and received in a sliding or press fit engagement by fastener hole 202, where it may be chemically bonded; or, alternatively support rod 105 may be attached to support block 200 by operation of a male threaded fastener protruding from the attaching end of support rod 105 and received in a threading engagement pin hole 202. Still further, support rod 105 may be attached to support block 200 by any means known in the art for mechanical attachment. Support block 200 may further comprise hole 203 in an upper surface. Hole 203, which may be a female threaded hole, may be utilized, for example, to attach an eye or hook to which a chain, rope, or other structure may be attached in order to suspend a light fixture assembly 001 of the invention from an overhead structure such as a beam or ceiling. Thus, hole 203 may be a female threaded hole adapted to receive male threads from an eye or a hook to which a chain, line, or other such structure may be attached. light group subassembly mounting block 204 may be attached to support rod 105 as described above in the description of FIG. 18, and as shown in FIG. 18.

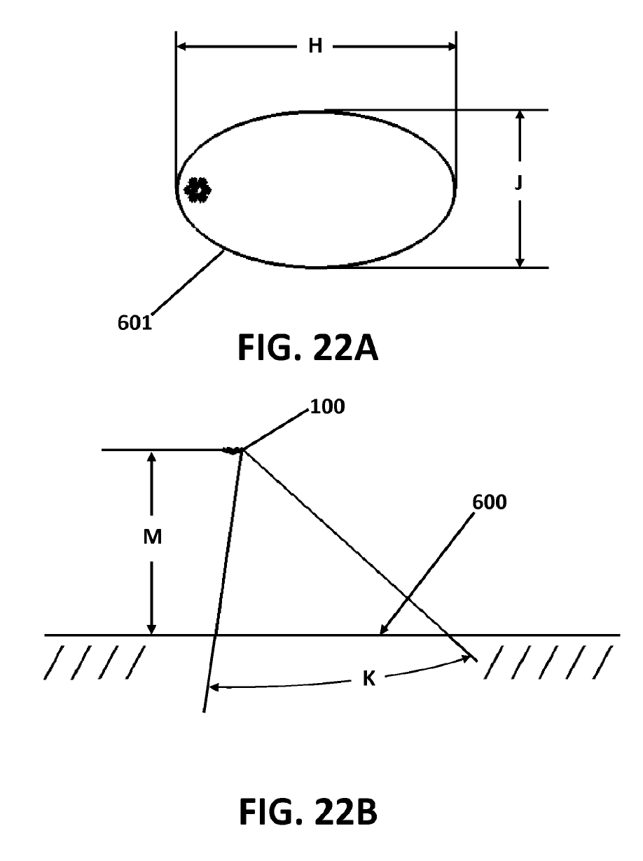

Referring now to FIGS. 22A and 22B, the light intensity distribution pattern of a single light reflector assembly 100 of the second embodiment of the invention is depicted. A single light reflector assembly 100 may exhibit a light intensity distribution having a periphery 601 defined by illumination major axis H and illumination minor axis J. A single light reflector of the invention may exhibit illumination angle K. The illumination periphery 601 will become larger as the height M of a single light reflector above the surface to be illuminated 600 is increased. However, as height M increases, the intensity of the light illuminating area to be illuminated 600 will decrease. Thus, illumination major diameter H and illumination minor diameter J are a function of height M. As an example, using the exemplary embodiments of the geometry of the light reflector assembly as described herein, when height M equals 20 feet, illumination major diameter H equals 25 feet 8 inches, illumination minor diameter J equals 14 feet 5 inches, and illumination angle K equals 56 degrees.

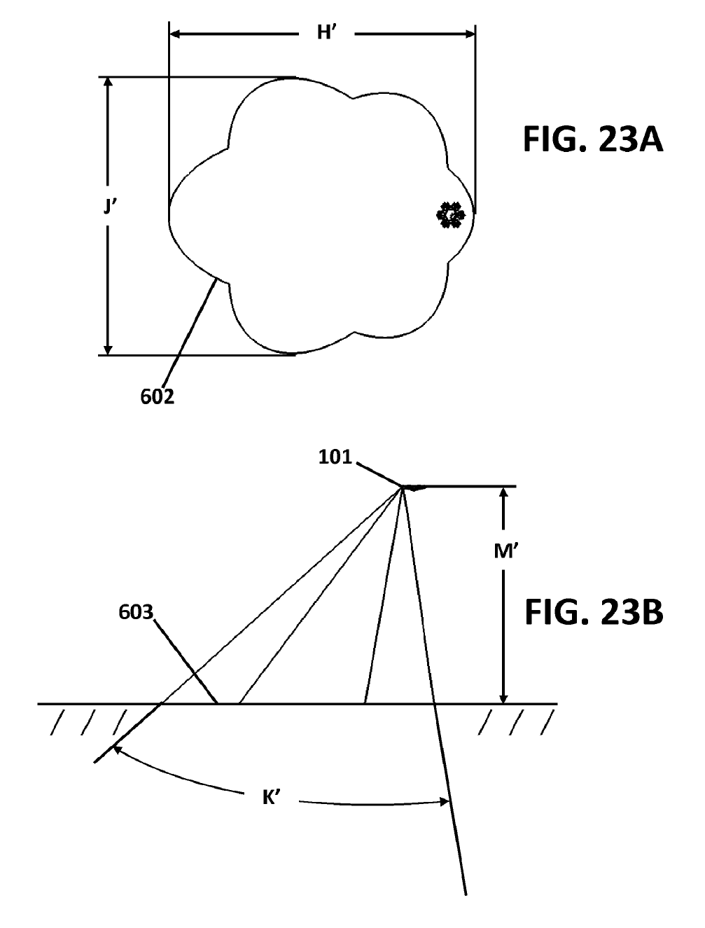

Referring now to FIG. 23A and 23B, the light intensity distribution pattern of a single light group subassembly 101, which in the example depicted comprises five light reflector assemblies 100, of the second embodiment of the invention is depicted. A single light group subassembly 101 may exhibit a light intensity distribution having a periphery 602 defined by illumination major axis H′ and illumination minor axis J′. A single light group subassembly 101 of the invention may exhibit illumination angle K′ having an illumination periphery 602. The illumination periphery 602 will become larger as the height M′ of a single light group subassembly 101 above the surface to be illuminated 603 is increased. However, as height M increases, the intensity of the area to be illuminated 603 will decrease. Thus, illumination major diameter H′ and illumination minor diameter J′ are a function of height M′. As an example, using the exemplary embodiments of the geometry of the single light group subassembly 101 as described herein, when height M′ equals 20 feet, illumination major diameter H′ equals 25 feet 8 inches, illumination minor diameter J′ equals 23 feet 2 inches, and illumination angle K′ equals 56 degrees.

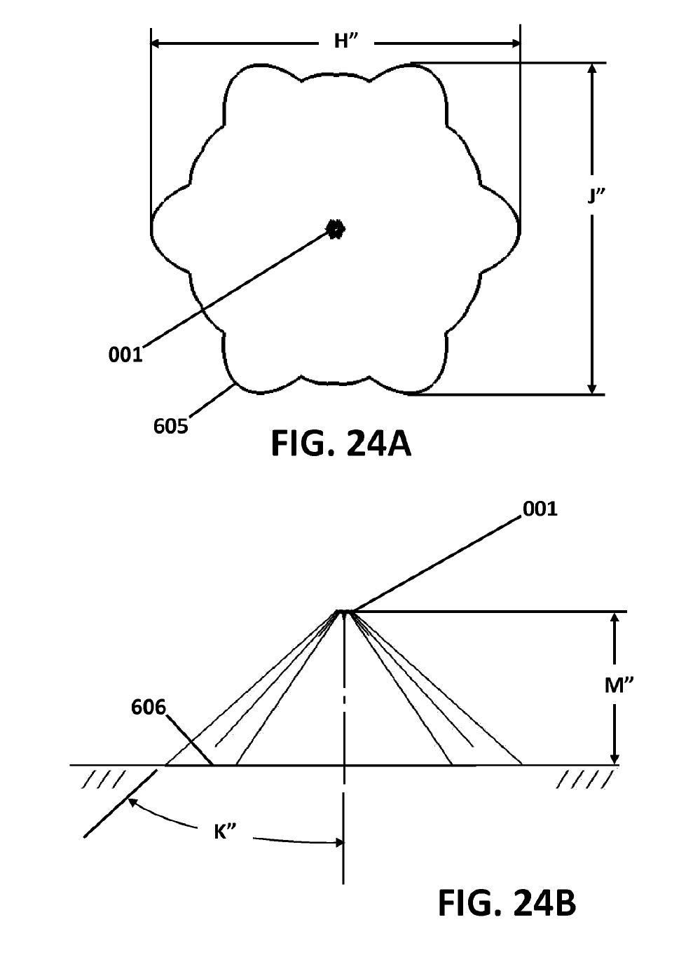

Referring now to FIG. 24A and 24B, the light intensity distribution pattern of a single light fixture assembly 001, which in the example depicted comprises six light group subassemblies 101, each comprising five light reflector assemblies 100, of the second embodiment of the invention is depicted. A single light fixture assembly 001 may exhibit a light intensity distribution pattern over an area having a periphery 605 defined by illumination axis H″ and illumination axis J″ and may exhibit illumination angle K″. The illumination periphery 605 will become larger as the height M″ of a light fixture assembly 001 above the surface to be illuminated 606 is increased. However, as height M″ increases, the intensity of the light illuminating area to be illuminated 606 will decrease. Thus, illumination diameter H″ and illumination diameter J″ are a function of height M″. As an example, using the exemplary embodiments of the geometry of the single light group subassembly 101 as described herein, when height M″ equals 20 feet, illumination diameter H″ equals 47 feet 7 inches, illumination diameter J′ equals 42 feet 4 inches, and illumination angle K″ equals 48 degrees.

The system of the invention may further comprise a plurality of light fixture assemblies 001 of the second embodiment of the invention in a typical application in which they are equally spaced apart and suspended from the ceiling of a building such as a museum, high bay assembly facility, or the like is depicted. The plurality of light fixture assemblies 001 of the second embodiment of the invention provide a desired light intensity distribution pattern over any desired area. The ability to achieve a desired light intensity distribution pattern over any desired area is important for any number of operations such as manufacturing and assembly operations, museums and displays, and the like.

The method of the invention comprises a method of illuminating a predetermined area by forming a desired light intensity distribution pattern on the area, comprising the steps of assembling a plurality of light emitting diode arrays; disposing the plurality of light emitting diode arrays in elliptically conical reflectors, and disposing the plurality of light emitting diode arrays in at least three planes relative to one another; providing electrical power to each of said plurality of light emitting diode arrays to stimulate the light emitting diode array to emit light at a desired intensity; wherein the shape, location and orientation of the plurality of reflectors provides a pre-determined combined asymmetrical light distribution pattern on the area; and wherein the light distribution pattern is a superposition of light emitted from the light emitting diode arrays, directly and reflected from the reflectors, onto the area.

The method may further be defined by the step of assembling a plurality of light emitting diode arrays further comprising the step of attaching the plurality of LED arrays and said plurality of reflectors to a thermally conductive support structure comprising a base plate comprised of a thermally conductive material and having a first side and a second side; a carbon foam layer; a back plate comprised of a thermally conductive material and having a first side and a second side; and a plurality of heat fins comprised of a thermally conductive material; wherein the light emitting diode arrays are attached to and in thermal communication with the first side of the base plate, the carbon foam is sandwiched between and in thermal communication with the second side of the base plate and the first side of said back plate, and the heat fins are attached to and in thermal communication with the second side of the back plate.

The method of the invention may be further defined as the base plate being comprised of oxygen-free thermally conductive copper.

The method may further be defined by the step of assembling a plurality of light emitting diode arrays further comprising the step of attaching the plurality of LED arrays and the plurality of reflectors to a thermally conductive support structure wherein the thermally conductive support structure comprises at least one light group subassembly having an axis, the at least one light group subassembly comprising: an inner support plate having a first side and a second side, comprised of thermally conductive material; an intermediate heat sink plate having a first side and a second side, comprised of thermally conductive material; a heat sink back plate having a first side and a second side, comprised of thermally conductive material; and a plurality of graphite foam blocks; wherein said plurality of light emitting diode arrays are attached to and in thermal communication with the first side of said inner support plate, at least some of the plurality of carbon foam blocks are sandwiched between and in thermal communication with the second side of said inner support plate and the first side of the intermediate heat sink plate; and wherein at least some of the plurality of carbon foam blocks are sandwiched between and in thermal communication with the second side of intermediate heat sink plate and the first side of the intermediate heat sink back plate.

The method may further be defined by the at least one light group subassembly being further defined as comprising a plurality of light group subassemblies.

The method may further be defined by each of the light group subassemblies being disposed in a circular pattern, each of the light group subassemblies in the circular pattern being evenly distributed in the pattern, and the circular pattern having a center, through which a lighting system axis 900, shown in FIG. 21, passes orthogonal to the plane of the circular pattern.

The method may further be defined by the axis of each of the light group subassemblies being canted at an offset angle to the lighting system axis to achieve a predetermined lighting intensity distribution pattern, and further, the offset angle being twenty degrees.

The method may further be defined as further comprising the step of determining a spatial light intensity distribution of the plurality of LED arrays.

The method may further be defined as further comprising the step of determining a combined light intensity distribution pattern of light energy emitted from the light emitting diode arrays onto an area, the combined light intensity distribution pattern comprising light energy directly radiated onto said area from the plurality of the light emitting diodes, and light energy reflected onto said area by the elliptically conical reflectors, utilizing the shape, location and orientation of said elliptically conical reflectors to determine the combined light intensity distribution pattern.

As described above and depicted in the figures, the various embodiments of the present invention are designed to be operative as a controllable intelligent lighting fixture. That is, the current technology uses timers which are inefficient, and prone to error. On the other hand, the present invention provides an intelligent lighting fixture, utilizing a microcontroller application such that the system turns light on in graduating sequence with decreasing ambient light, turns light off in graduating sequence with increasing ambient light, is optionally programmable via and external device (e.g., an IPAD or other mobile electronic communication device), provides an additional 15-20% in economic savings and 15-20% in additional energy savings.

In a first study of parking lot luminaires, the initial conditions were 12 metal halide luminaires at 520 W, for a cost of $0.15 per Kw, which is an annual cost of approximately $2,000-4,000 depending upon the general installed and integrated version. After switching to a lighting system according to the present invention, i.e., 12 LED luminaires at 43 W, for a cost of $0.15 per Kw, and a projected annual cost of $330, the result was a greater than 90% savings where the luminaire sell price is $825.

In a second study of flood lights, the initial conditions were 12 metal halide bulbs at 100 W, for a cost of $0.15 per Kw, which is an annual cost of $520 (i.e., cost of replacement). After switching to a lighting system according to the present invention, i.e., 12 LED luminaires at 15 W, for a cost $0.15 per Kw, and a projected annual cost of $77, the result was a greater than 85% savings.

Also, when comparing the lighting efficiency and coverage of the lighting system according to the invention versus a competing lighting system using a parking lot light as an example, the first known system was a Lithonia LED light system at 109 W providing a coverage area of 8,800 sq. ft. Where a lighting system in accordance with the invention is used, with only 43 W, a coverage area of 15,000 sq. ft. is provided, which is approximately a 60% savings. Similarly, in a second comparison using a 400 W metal halide parking lot light at 520 W to provide a coverage of 15,000 sq. ft. (Metal halides are the current standard lighting used in 90+% of existing parking lot lights), an LED parking lot light system or assembly according of the invention uses only 43 W to provide the same coverage of 15,000 sq. ft., which yields a 92% savings.

Also described is a comparison between a next generation LED luminaire with a 400 W metal halide HID lamp. Initially, 12 metal halide luminaires were used around a building, with each 400 W bulb and ballast system consuming between 500-520 W (measured and verified by two means, using a current meter and calculated via a direct amperage measurement with a multi-meter in series and then taking a voltage measurement for that luminaire) The installed features were harsh to the viewer and a more efficient, greener, and more visibly pleasing design could be produced. First, the ground area to be illuminated was evaluated. Second, one lamp was segregated and the amount of light reaching the ground over 5 foot increments left and right and forward and rear of the pole were measured. Resulting were a best case and worst case for light output since the measured system was running for some amount of time.

The initial Lumen value of the 400 W (500-520 W measured) metal Halide bulb technology is well over 35,000 lumens. The “lifetime” of a metal halide bulb can range anywhere from 8,000 hours onward. Depending on how the bulb is installed (horizontal or vertical) the lumen depreciation can be decreased by 20% in the first 2,000 hours. The amount of trapped light (light not reaching an intended targeted surface) can range from 24% to upwards of 58% depending on the style and shielding pattern of the optics.

A well designed and well balanced LED system will have a loss of light over the first 10,000 hours of less than 2%. Provided is test data according Nichia (LED manufacturer used in the lighting technology of the present invention) for samples of the LED used in the design, e.g., 88° C. ambient, 88° C. LED junction temperature test point, and drive current of 693 mA. The samples under the test lost approximately 4% over the 10,000 hours. The test performed by Nichia used a set of parameters that are several times above the running current of the design according to the present invention and calculations show that the junction temperature of the present invention are approximately 20° C. above ambient under most conditions. The combination of the LEDs are run (i.e., current level) and multi stage heat sink design contribute to the consistent performance achieved by the design according to the present invention.

The custom designed optics according to the invention contribute to the overall efficiency of the lighting design. The amount of trapped light within the design is near 0%, as there are some normal losses due to reflections as the light leaves the housing but such losses are small. Preferably, each LED is oriented to illuminate a specific area on the ground with enough overlap so the resultant coverage area is even. In an isofootcandle chart for a brand new 400 W (i.e., 500-520 W measured) metal halide lamp, after approximately 2,000 hours the area directly beneath the bulb reads approximately 3-4 fc and the overall illuminated area is diminished by upwards of 25%. In an isofootcandle chart showing the light according to the present invention mounted at the same height as the original metal halide, the same coverage area is achieved with only 4,000 lumens of light.

The easiest way to confirm the function, efficiency and effectiveness of an LED design is by thermal performance The LED requires a thermal state to be maintained at reasonable levels, which include the amount of heat generated by the LED that must be removed from the system as efficiently as possible. The heat sink design in accordance with the preferred embodiment of the invention allows the heat generated by the LED to be removed from the package area very quickly. That is, each stage of the heat sink transfers the thermal energy to the light fixture chassis. To verify the LED design the junction temperature (Tⱼ) of the LED was measured while running at the desired current. The LED had a test point which was directly connected to the die of the package. The following calculation was then applied to obtain the Tⱼ of the LED package:

Tⱼ=T_{c}+RΘ_{jc} *W (where Tⱼ is LED junction temperature in ° C., where T_{c} is test point temperature in ° C., where RΘ_{jc} is the thermal resistance from the junction to a T_{c} measuring point in ° C./W, and where W is the input power in watts);. We then apply our test conditions to the equation and come up with the following data points: T_{j =}42.5 ° C.+1.7° C./W *4.78 W; and T_{j =}50.626° C. (where ambient temperature was 21° C., where a thermal resistance of 1.7° C./W was used as a worst case scenario, and where the actual Tⱼ could be as low as 49.19° C. using a typical value of 1.4° C./W). Accordingly, the system and method of the present invention substantially reduces the energy consumption of a wide range of lighting fixtures including those using LEDs, and reduces maintenance and replacement cost due to the extended lifetime.

On average the Tⱼ of each LED is 20° C. above ambient verifying that the design is sound and allows a lifetime and performance in any climate. The industry standard for life testing LEDs is called TM-21, and such TM-21 testing has been performed by Nichia on the LED being used in design of the present invention. The calculations and data set are below.

| Time | Ln (avg.) |
|---|---|
| 0 h | 0 |
| 496 h | −0.0281 |
| 1014 h | −0.0269 |
| 1701 h | −0.0336 |
| 2441 h | −0.0332 |
| 3132 h | −0.0319 |
| 3819 h | −0.0372 |
| 4485 h | −0.0368 |
| 5200 h | −0.0400 |
| 6008 h | −0.0411 |
| 6817 h | −0.0397 |
| 7603 h | −0.0391 |
| 8436 h | −0.0422 |
| 9198 h | −0.0438 |
| 10009 h | −0.0446 |

Curve-fit equation: Ø(t) = B^{(-αt)}; Lumen maintenance life equation: L70 = ln(B/0.7)/α.

Typically LED manufactures conduct TM-21 testing for either 6,000 hours of 10,000 hours. Once the test is performed the life time is then extrapolated by 6 times and that becomes the reported L70 value. Such a test has been performed on the completed fixture according to the present invention. The initial testing performed by NICHIA, a typical LED manufacturer, allows for verification of the present design and provides a starting point. Applicant's related testing is similar to such thermal and time based testing.

Thermal testing results for a multi-stage heat sink, such as the one used in accordance with the present invention, demonstrate the effectiveness of the heat sink technology of the present invention. The test was performed within a closed system with no external thermal path. The test LED was attached to a 76.2 millimeter (mm)×50.8 mm copper base which was 0.81 mm thick. Probes were directly attached to the test pad that reports a value to calculate the Tⱼ of the die which was discussed above. Stage 1 demonstrates how the LED behaves within the system with no additional thermal mass other than the copper base. When the system reached a steady thermal state the second level of heat sink was added (i.e., stage 2). An immediate drop in temperature was observed, but once the system was saturated and reached an equilibrium point the final stage was added. The final temperature delta between LED and copper only to LED, copper, and full heat sink was 16° C. When the LED thermal path is actually attached to the thermal mass of the light fixture the Tⱼ value will be drastically reduced again.

A sample cost analysis of the above testing example (e.g., Metal Halide 400 W (500 W -520 W with ballast) is as follows:

| | Single System | Multiple Systems |
|---|---|---|
| Number of Units | 1 | 12 |
| Power (W) | 500 | 6,000 |
| Hours on per day | 12 | 144 |
| Kwh | 6 | 72 |
| Energy cost ($) | $0.15 | $1.8 |
| Daily cost ($) | $0.9 | $10.8 |
| Monthly cost ($) | $27 | $324 |
| Yearly cost ($) | $324 | $3,888 |

Thus, the Return On Investment after installing the lighting system of the invention is approximately 2-3 years. A possible second testing may involve 200 W metal halide bulbs which may further decrease system power to 20 W while still keeping a ROI of less than 3 years.

Color temperature and the shift in color over time are two very important factors when considering luminaires of any type. Metal halide bulbs usually advertise a color temperature of around 4,000-5,000 K, yet their apparent color temperature looks much higher due to the spikes that occur within their spectral distribution in the blue regions. Also, the color temperature of a metal halide lamp will change drastically over its lifetime. Preferably used are white LEDs with a color temperature of approximately 3,900-4,000 K and a CRI of at least 85. Such a color temperature works very well for both comfort level and glare control. Many LED manufacturers use LEDs with very high color temperatures to give the perceived feeling of increased brightness due to the eyes sensitivity to the blue region of the visible spectrum.

Thus, the present invention provides an innovative LED luminaire that surpasses technologies like metal halide, high pressure sodium, induction, and any other “bulb” like technology on the market today. Deviation from the normal LED luminaire design achieved an optical system which surpasses the traditional normal LED grid array. The lifetime of the lighting fixtures or assembly according to the present invention surpasses 185,000 hours and provides a lighting method and system that will provide quality light for years to come.

Such LED arrays are preferably recyclable and free of toxic metals such as lead and mercury which are found in conventional HID lighting. The prior lighting fixtures to be replaced suffer from substantial loss of brightness quickly over relatively short life and produce trapped light which does not escape the housing due to inefficiencies with the technology. Because of the >10 year life expectancy of the LED array of the present invention there may be a significant land fill reduction as compared to with HID lighting fixtures in which one could expect to re-lamp 5 times over that same time period.

In the claims, means or step-plus-function clauses are intended to cover not only the structures described or suggested herein as performing the recited function, but all equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

### INDUSTRIAL APPLICABILITY

The several objects of the Optical LED Lighting System and Method of the invention are: to provide a new and improved LED light assembly which efficiently uses a high-output LED to produce highly favorable illumination characteristics for areas desired to be lighted, such as assembly buildings, car parks, and the like; to provide an improved lighting fixture, system and method utilizing the next generation LEDs to provide improved LED heat management, reduced energy consumption, and which maximizes the advantages of LED lighting; to provide a lighting fixture, system and method having a performance advantage over traditional lighting solutions and other known LED lighting solutions; to provide a multi-reflector LED lighting fixture having a longer life than traditional lighting solutions depending upon the LED quality and junction temperature management (i.e., providing junction temperatures substantially lower than other LED lighting solutions); to provide a system and method for an LED lighting system and method providing lower maintenance costs due to longer life spans thereof; to provide a system and method for an LED lighting system that typically last two times longer than traditional LED lighting solutions, and have significantly lower operating costs by requiring less maintenance and less frequent replacement; to provide a novel multi-reflector LED lighting fixture or solution using the highest quality LED arrays, leveraging color and light distribution characteristics of various LED arrays, managing the junction temperature of the LED arrays utilizing proprietary technology, and employing unique methodologies to further reduce energy consumption; and to provide an enhanced method and system for lighting solutions for parking facilities, vehicle dealerships, university facilities, government or municipal facilities, warehouse facilities, athletic fields or facilities, etc.

What is claimed is:

1. A lighting system for illuminating an area, comprising:
a plurality of light emitting diode arrays, wherein each of said light emitting diode arrays is disposed within an elliptically conical reflector having an axis and an optically reflective interior surface; and
a thermally conductive support structure having an axis;
wherein each of said light emitting diode arrays and each of said elliptically conical reflectors are attached to and in thermal communication with said support structure, and
wherein said attachment to said support structure is thermally conductive so that heat is transferred from each of said light emitting diode arrays through said support structure to a heat dissipating heat sink, and
and wherein at least one of light emitting diode arrays is attached to said support structure such that said the axis of said conical reflector is disposed at a pre-determined angle to said support structure axis.

2. The lighting system of claim 1, wherein said thermally conductive support structure comprises:
a base plate comprised of a thermally conductive material and having a first side and a second side;
a carbon foam layer;
a back plate comprised of a thermally conductive material and having a first side and a second side; and
a plurality of heat fins comprised of a thermally conductive material;
wherein said light emitting diode arrays are attached to and in thermal communication with said first side of said base plate, said carbon foam is sandwiched between and in thermal communication with said second side of said base plate and said first side of said back plate, and said heat fins are attached to and in thermal communication with said second side of said back plate.

3. The lighting system of claim 1, wherein said base plate is comprised of oxygen-free thermally conductive copper.

4. The lighting system of claim 3, wherein said back plate is comprised of aluminum.

5. The lighting system of claim 4, wherein said heat fins are comprised of copper.

6. The lighting system according to claim 1, wherein a shape, configuration and profile of said reflectors provides a pre-determined non-circular intensity distribution pattern of optical energy on a planar surface when said light emitting diode arrays transmit light.

7. The lighting system according to claim 4, wherein the intensity distribution pattern is a superposition of light reflected from each said reflector and light directed into the lighting intensity distribution pattern directly from the LED array.

8. The lighting system according to claim 1, wherein a shape, configuration and profile of said reflectors provides a pre-determined non-circular asymmetrical lighting intensity distribution pattern.

9. The lighting system according to claim 1, wherein each said reflector axis is disposed at a predetermined angle with respect to each other said reflector axis.

10. The lighting system according to claim 1, wherein said base support member is further divided into a plurality of support plates, each support plate attached to one of said reflectors and one of said light emitting diodes, and wherein each support plate is not coplanar to each adjacent said plate.

11. The lighting system according to claim 10, wherein said plurality of support plates are disposed in at least three different planes relative to each other.

12. The lighting system of claim 1, wherein said thermally conductive support structure comprises at least one light group subassembly having an axis, comprising:
an inner support plate having a first side and a second side, comprised of thermally conductive material;
an intermediate heat sink plate having a first side and a second side, comprised of thermally conductive material;
a heat sink back plate having a first side and a second side, comprised of thermally conductive material;
a plurality of graphite foam blocks;
wherein said plurality of light emitting diode arrays are attached to and in thermal communication with said first side of said inner support plate, at least some of said plurality of carbon foam blocks are sandwiched between and in thermal communication with said second side of said inner support plate and said first side of said intermediate heat sink plate; and
wherein at least some of said plurality of carbon foam blocks are sandwiched between and in thermal communication with said second side of intermediate heat sink plate and said first side of said intermediate heat sink back plate.

13. The lighting system of claim 12, wherein said lighting system is further defined as comprising a plurality of light group subassemblies.

14. The lighting system of claim 13, wherein each of said light group subassemblies is disposed in a circular pattern, each of said light group subassemblies in the circular pattern being evenly distributed in said pattern, and said circular pattern having a center, through which a lighting system axis passes orthogonal to the plane of the circular pattern.

15. The lighting system of claim 14, wherein said axis of each of said light group subassemblies is canted at an offset angle to said lighting system axis to achieve a predetermined lighting intensity distribution pattern.

16. The lighting system of claim 15, wherein said offset angle is twenty degrees.

17. The lighting system of claim 12, wherein said plurality of light emitting diode arrays is further defined as five light emitting diode arrays.

18. The lighting system of claim 13, wherein said plurality of light group subassemblies is further defined as six light group subassemblies.

19. The lighting system of claim 18, wherein said plurality of light emitting diode arrays in each of said plurality of light group subassemblies is further defined as comprising six light emitting diode arrays.

20. A method of illuminating a predetermined area by forming a light intensity distribution pattern on said area, said method comprising the steps of:
assembling a plurality of light emitting diode arrays;
disposing said plurality of light emitting diode arrays in elliptically conical reflectors, and disposing said plurality of light emitting diode arrays in at least three planes relative to one another;
providing electrical power to each of said plurality of light emitting diode arrays to stimulate said light emitting diode array to emit light;
wherein the shape, location and orientation of said plurality of reflectors provides a pre-determined combined asymmetrical light distribution pattern on said area; and
wherein said light distribution pattern is a superposition of light emitted from said light emitting diode arrays, directly and reflected from said reflectors, onto said area.

21. The method according to claim 20, wherein said step of assembling a plurality of light emitting diode arrays further comprises the step of attaching said plurality of LED arrays and said plurality of reflectors to a thermally conductive support structure comprising:
a base plate comprised of a thermally conductive material and having a first side and a second side;
a carbon foam layer;
a back plate comprised of a thermally conductive material and having a first side and a second side; and
a plurality of heat fins comprised of a thermally conductive material;
wherein said light emitting diode arrays are attached to and in thermal communication with said first side of said base plate, said carbon foam is sandwiched between and in thermal communication with said second side of said base plate and said first side of said back plate, and said heat fins are attached to and in thermal communication with said second side of said back plate.

22. The method according to claim 21, wherein said base plate is comprised of oxygen-free thermally conductive copper.

23. The method according to claim 20, wherein said step of assembling a plurality of light emitting diode arrays further comprises the step of attaching said plurality of LED arrays and said plurality of reflectors to a thermally conductive support structure wherein said thermally conductive support structure comprises at least one light group subassembly having an axis, said at least one light group subassembly comprising:
an inner support plate having a first side and a second side, comprised of thermally conductive material;
an intermediate heat sink plate having a first side and a second side, comprised of thermally conductive material;
a heat sink back plate having a first side and a second side, comprised of thermally conductive material;
a plurality of graphite foam blocks;
wherein said plurality of light emitting diode arrays are attached to and in thermal communication with said first side of said inner support plate, at least some of said plurality of carbon foam blocks are sandwiched between and in thermal communication with said second side of said inner support plate and said first side of said intermediate heat sink plate; and
wherein at least some of said plurality of carbon foam blocks are sandwiched between and in thermal communication with said second side of intermediate heat sink plate and said first side of said intermediate heat sink back plate.

24. The method according to claim 23, wherein said at least one light group subassembly is further defined as comprising a plurality of light group subassemblies.

25. The method according to claim 24, wherein each of said light group subassemblies is disposed in a circular pattern, each of said light group subassemblies in the circular pattern being evenly distributed in said pattern, and said circular pattern having a center, through which a lighting system axis passes orthogonal to the plane of the circular pattern.

26. The method according to claim 25, wherein said axis of each of said light group subassemblies is canted at an offset angle to said lighting system axis to achieve a predetermined lighting intensity distribution pattern.

27. The method according to claim 26, wherein said offset angle is twenty degrees.

28. The method according to claim 20, further comprising the step of determining a spatial light output distribution of said plurality of LED arrays.

29. The method according to claim 20, further comprising the step of determining a combined light intensity distribution pattern of light energy emitted from said light emitting diode arrays onto an area, said combined light intensity distribution pattern comprising light energy directly radiated onto said area from said plurality of said light emitting diodes, and light energy reflected onto said area by said elliptically conical reflectors, utilizing the shape, location and orientation of said elliptically conical reflectors to determine said combined light intensity distribution pattern.
